(19) United States
(12) Patent Application Publication
(10) Pub. No.: US 2005/0240457 A1
(43) Pub. Date: Oct. 27, 2005

(54) Systems, methods and computer program products for facilitating evaluation of job applicants by search committees

(76) Inventors: Samuel B. Connally, Las Vegas, NV (US); Lori Ann Preiss, Wilmington, NC (US); Mark B. Steelman, Wilmington, NC (US)

Correspondence Address: MYERS BIGEL SIBLEY & SAJOVEC, PO BOX 37428, RALEIGH, NC, 27627, US

(21) Appl. No.: 11/042,830

(22) Filed: Jan. 25, 2005

Related U.S. Application Data
(60) Provisional application No. 60/540,572, filed on Jan. 30, 2004.

(51) Int. Cl. G06F 17/60

(52) U.S. Cl. 705/7

(57) ABSTRACT

Evaluation of job applicants by academic institution Search Committees is facilitated. Applicants can apply online for vacancies by entering specific information and/or attaching documents. The applicant's information is then organized and displayed for Search Committee Members online. The Search Committee Members can rate each applicant's suitability for the vacancy online based on the applicant's qualifications. The ratings are compiled for the Search Committee chair. A master screen is provided that follows the search process as it progresses the various stages of narrowing the applicant pool. Ratings may be indicated by symbols rather than grades, and the members of the Search Committee may be expanded to include interviewers at an on-campus interview stage.

### CROSS-REFERENCE TO RELATED APPLICATION

This application claims the benefit of provisional Application No. 60/540,572, filed Jan. 30, 2004, entitled Systems, Methods and Computer Program Products for Facilitating Evaluation of Job Applicants by Academic Search Committees, the disclosure of which is hereby incorporated herein by reference in its entirety as if set forth fully herein.

### FIELD OF THE INVENTION

This invention relates to data processing systems, methods and computer program products, and more particularly employment data processing systems, methods and computer program products.

### BACKGROUND OF THE INVENTION

Academic Search Committees are widely used to evaluate applicants for job vacancies at academic institutions such as universities or colleges. Although academic Search Committees have been used effectively to evaluate and hire qualified applicants, the Search Committee process may be unduly time consuming. Moreover, the process may not be conducive to independent evaluation by committee members, and may be difficult to administer.

### SUMMARY OF THE INVENTION

Some embodiments of the present invention provide systems, methods and/or computer program products for facilitating evaluation of job applicants by academic institution Search Committees. In some embodiments, hardware and/or software is provided that supports Search Committees engaged in evaluating applicants for job vacancies. Applicants can apply online for vacancies by entering specific information and/or attaching documents. The applicant's information is then organized and displayed for Search Committee Members online. The Search Committee Members can rate each applicant's suitability for the vacancy online based on the applicant's qualifications. The ratings are compiled for the Search Committee chair. In some embodiments, a master screen is provided that follows the search process as it progresses the various stages of narrowing the applicant pool. Ratings may be indicated by symbols rather than grades, and the members of the Search Committee may be expanded to include interviewers at an on-campus interview stage.

### BRIEF DESCRIPTION OF THE DRAWINGS

FIG. 1 is a block diagram of systems, methods and/or computer program products according to various embodiments of the present invention.

FIGS. 2-8 are flowcharts of operations that may be performed according to various embodiments of the present invention.

FIGS. 9-54 are screen shots of user interfaces that may be provided according to various embodiments of the present invention.

### DETAILED DESCRIPTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The present invention is described below with reference to block diagrams and/or flowchart illustrations of methods, apparatus (systems) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Embodiments of the invention support academic Search Committees engaged in evaluating applicants for job vacancies. Some embodiments of the invention allow applicants to apply online for vacancies by entering specific information and/or attaching documents to an electronic application. Some embodiments of the invention organize and display the applicants' information to the Search Committee Members online. Some embodiments of the invention allow the Search Committee Members to rate each applicant's suitability for the vacancy based on his/her qualifications. Some embodiments of the invention compile the ratings for the Search Committee chair.

Embodiments of the invention can support a typical university or college Search Committee process of narrowing a broad applicant pool into a smaller number through successive reviews of the applicants, and then identifying a small group of applicants to be interviewed by the hiring official and other interested campus employees. For example, the Search Committee may receive 100 applications for a vacancy. Some embodiments of the invention place all new applicants at level 1. In the initial review, the Search Committee Members may screen out, for example, 40 applicants who do not meet the minimum advertised educational degree requirement. The remaining, for example, 60 applicants who do meet the minimum educational requirement are moved to level 2 in some embodiments of the invention. The Search Committee Members then review the 60 applications at level 2, and screen out, for example, 40 who do not have the minimum number of years of experience. The remaining 20 applicants who do meet the minimum number of years of experience are moved to level 3 in some embodiments of the invention. The Search Committee Members then review the 20 applicants at level 3 and screen out, for example, 12 who do not have the preferred type of experience. The remaining eight applicants are then moved to level 4, in some embodiments of the invention. Eight applicants is a manageable number for conducting telephone interviews, reference checks, and/or on-site interviews, depending on the methodology of the search process.

Some embodiments of the invention can facilitate a consensus building approach to determining the status of the applicants. In some embodiments of the invention, the Search Committee Members independently go online to review each applicant's information, and rate each applicant as either “Highly Recommended” for further consideration, “Moderately Recommended” for further consideration, or “Not Recommended” for further consideration. In some embodiments of the invention, initially, Search Committee Members are not able to see each other's ratings of the applicants. Thus, some embodiments of the invention allow Search Committee Members to evaluate the applicants online independently and then meet as a committee to discuss their evaluations. In some embodiments of the invention, the Search Committee chair can download the evaluation ratings and distribute them to the committee members in advance of the meeting. In this way, the committee members can better prepare for discussing the applicants, particularly ones who received opposing evaluations. In some embodiments of the invention, the evaluation ratings are represented by the X, /, and O symbols, which can promote discussion and consensus building among Search Committee Members and discourage averaging of scores to determine an applicant's status.

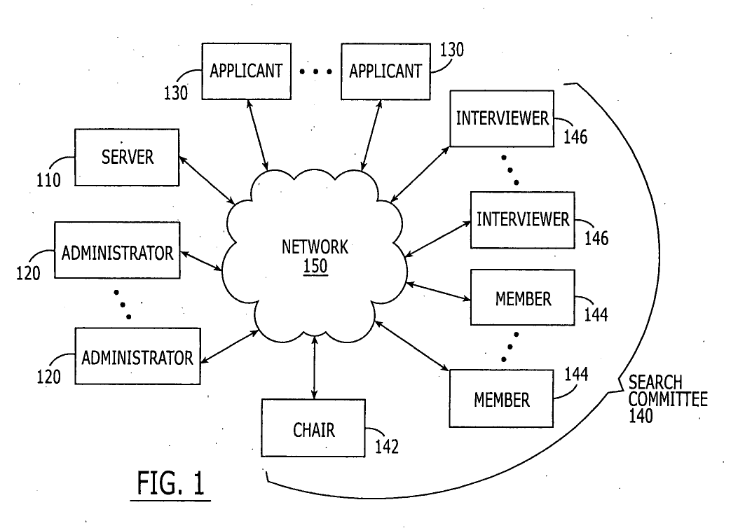

FIG. 1 is a block diagram of systems, methods and/or computer program products according to some embodiments of the present invention. These embodiments include a server 110, one or more administrator terminals 120, one or more applicant terminals 130, and one or more Search Committee terminals 140, that are interconnected via a wired and/or wireless private and/or public network 150 including the Internet. The Search Committee terminals 140 can include one or more Search Committee chair terminals 142, one or more Search Committee Member terminals 144 and/or one or more interviewer terminals 146.

The server 110 and each of the terminals 120, 130 and 140 may be embodied in one or more personal, application, enterprise, pervasive and/or embedded computing devices. Moreover, the functionality shown in the individual blocks of FIG. 1 may be merged, combined and/or distributed. The terminals 120-146 may be embodied as a wireless and/or wired terminal. The wired terminal may include a workstation. The wireless terminals may include cellular and/or satellite radiotelephones, Personal Communications System (PCS) terminals that may combine a cellular radiotelephone with data processing, facsimile and/or data communication capabilities, Personal Digital Assistants (PDA) that can include a radio frequency transceiver and a pager, Internet/intranet services, Web browser, organizer, calendar and/or Global Positioning System (GPS) receiver and/or conventional laptop and/or palmtop computers or other appliances which include a radio frequency receiver.

In some embodiments of the present invention, the server 110 is embodied as a personal computer that includes a Web server, the terminals 120-146 are embodied as personal computers that include Web clients, and the network 150 is the World Wide Web. The server 110 may include one or more computers running a set of server applications which can include, but are not limited to, a Web server, a database server and an application server. In other embodiments, a separate server 110 need not be provided, but the functionality of a server may be embodied in one or more of the terminals 120-146.

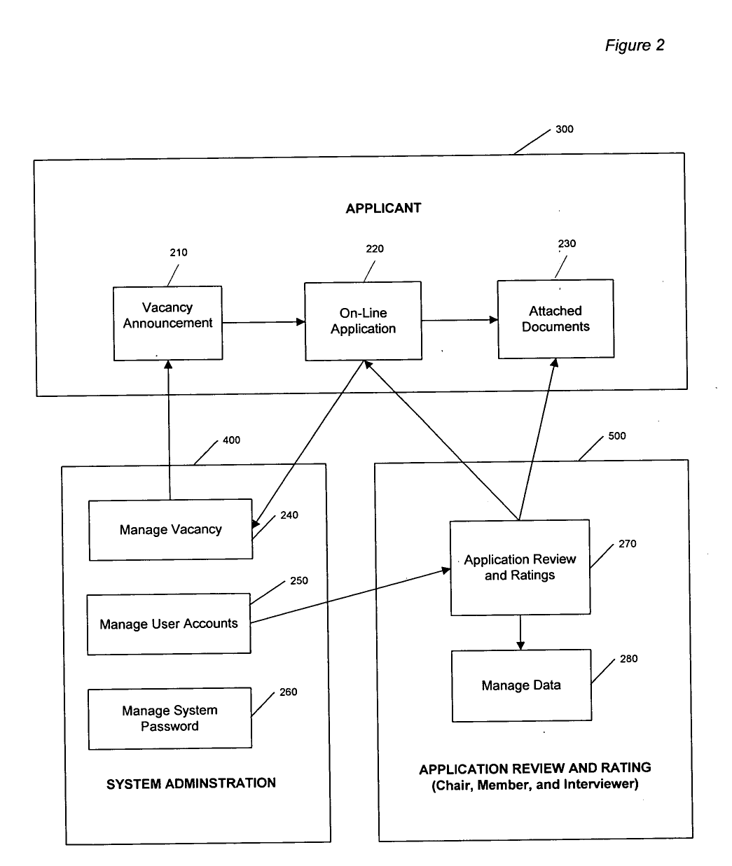

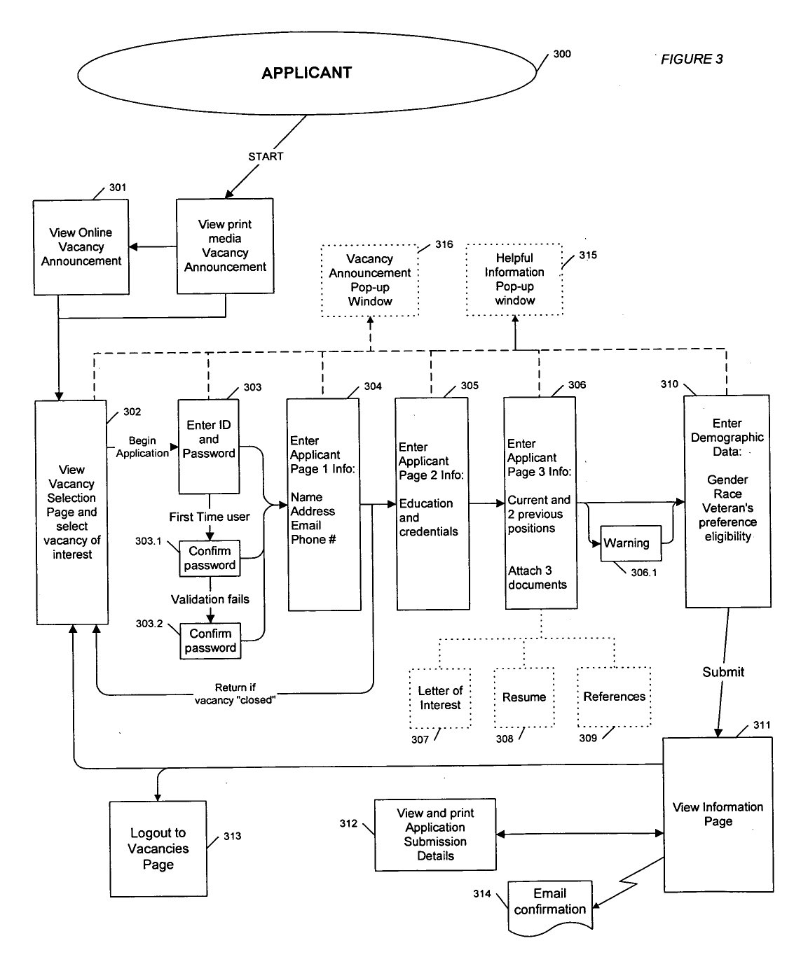

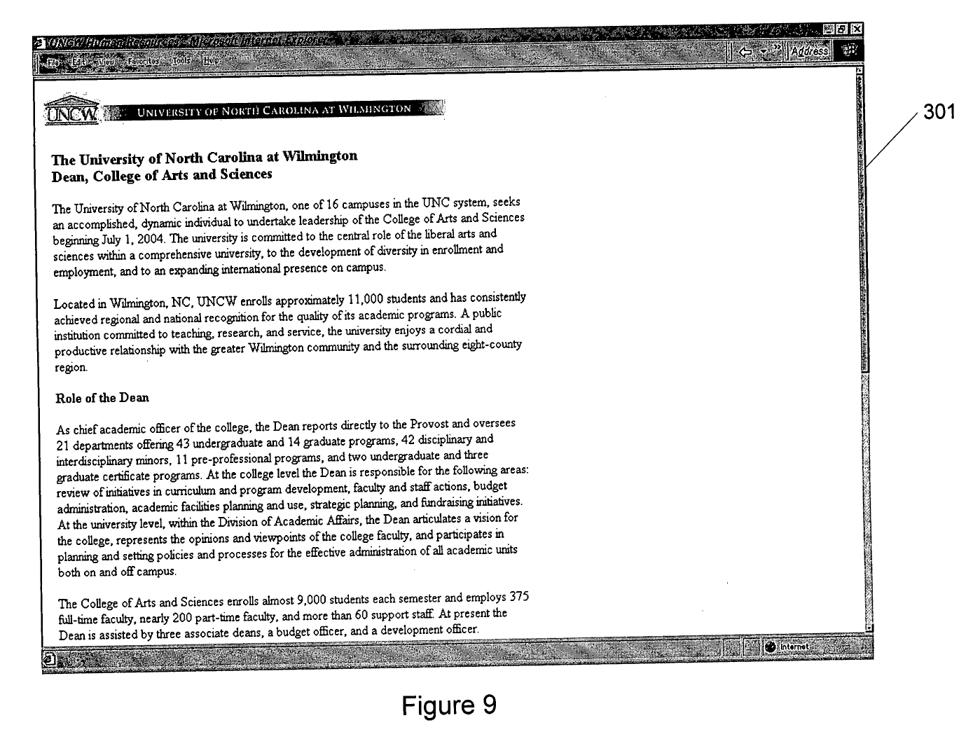

An overall description of functionalities that may be embodied in the blocks of FIG. 1 will be provided in connection with FIG. 2. Detailed embodiments then will be described in connection with FIGS. 3-8. A user interface according to some embodiments of the invention then will be described in connection with FIGS. 9-54.

Referring again to FIG. 1, in general, a job applicant may first read a vacancy announcement and decide to apply for the job, at an applicant terminal 130. The applicant submits an online application by entering information regarding his/her credentials and attaching, for example, up to three documents, which are typically a letter of interest, a resume, and a list of references, at an applicant terminal 130. In other embodiments, fewer than or more than three documents may be attached. The server 110 can automatically acknowledge receipt of the online application by sending an email to the applicant.

Committee members can review each applicant online at member terminal 144 and enter a rating. Ratings are compiled by the server 110 for use by the Search Committee chair at the chair terminal 142 and may be used in meetings to determine the status of applicants. Applicants to be retained for further consideration may be moved to a next level. Committee members may use new and more stringent criteria in successive reviews to narrow the applicant field to a small number recommended for interviews.

Other individuals, designated as Interviewers, can be added to the system at interviewer terminals 146, which may allow them to see only the online applications for the individuals they are to interview. They may not be able to see the rest of the applicant pool. The Search Committee chair can download information on the applicants to analyze the applicant pool and to generate letters (e.g. with a mail merge application) to the applicants to advise them of the outcome of the selection process. The System Administrator can download information on the applicants for EEO analysis and to generate letters to the applicants to advise them of the outcome of the selection process, at the administrator terminal 120.

Some embodiments of the present invention can provide one or more of the following functions for job applicants, using, for example, an applicant terminal 130 of FIG. 1:

1. Allow or require a job applicant to enter an applicant-selected ID and password.

2. Once an ID and password are correctly entered, allow or require job applicants to enter the following information as an application to a specific vacancy: name, address, and email address. Furthermore, the applicant is allowed to enter current and previous 2 employers, three highest degrees, additional information on related skills and qualifications, race, and sex, and veteran's status. Some embodiments of the invention also can allow a job applicant to attach three documents or files, for example, a letter of interest, resume, and list of references.

3. Send an immediate email acknowledgement to the applicant that the information was successfully received.

4. Allow the applicant to use the previously entered ID and password to access the previously submitted application and make corrections and/or attach new documents.

5. Allow the applicant to see and print a summarization of the information he/she entered.

Some embodiments of the present invention can provide one or more of the following functions for Search Committee Members, using, for example a member terminal 144 of FIG. 1:

6. Allow Search Committee Members to enter the system (with an assigned user ID and password) and review applicant information. Upon their first time using the system, the system may allow the Search Committee Member to change his/her password.

7. For the Search Committee Member, display all applicants on a master screen in the order in which their electronic applications were received. Some embodiments of the invention can provide for 5 levels, in which applicants may move up based on screening criteria. The master screen displays the level to which each applicant has moved, based on decisions made by the Search Committee.

8. Initially assign and display all new applications at “Level 1”.

9. From the master screen, allow Search Committee Members to select “Level 1” and then view a list of all applicants (name and sequence number) at “Level 1”.

10. From the list of all applicants at “Level 1”, allow the Search Committee Member to click on the applicant's name, which then displays Page 1 of the applicant's information. Page 1 displays the applicant's name, address, email address, two phone numbers, the applicant's three highest degrees, and additional credentials entered by the applicant.

11. From Page 1 of the applicant's information, allow the Search Committee Member to open Page 2 of the applicant's information. Page 2 displays the applicant's current and past two employers, and allows the Search Committee Member to open the documents submitted by the applicant. Page 2 also allows the Search Committee Member to enter a rating score of “Highly Recommended”, “Moderately Recommended”, or “Not Recommended” in some embodiments of the invention. Page 2 also allows the Search Committee Member to write in comments about the applicant's qualifications. The rating score and comments are made independently of all other Search Committee Members.

12. From Page 2 of the applicant's information, allow the Search Committee Member to view and print a summary of the applicant's information, and the rating score and comments entered by the Search Committee Member. The rating score of “Highly Recommended”, “Moderately Recommended”, and “Not Recommended” are represented by the following symbols in some embodiments of the invention: “Highly Recommended”: X, “Moderately Recommended”: /, and “Not Recommended”: O.

13. From Page 2 of the applicant's information, allow the Search Committee Member to return to the list of applicants at “Level 1”. If the Search Committee Member has entered a rating score (X, /, or 0), the rating score is displayed next to the applicant's name.

14. When at the list of applicants at “Level 1”, allow the Search Committee Member to select another applicant and proceed through the process of reviewing and rating that applicant; or allow the Search Committee Member to select an applicant he/she has already rated and review that applicant's information again, and change the rating score or comments that he/she previously entered on the applicant.

15. When at the list of applicants at “Level 1”, allow the Search Committee Member to logout of the system or return to the master list of applicants.

16. Allow the Search Committee Member to repeat functions 10 through 15 for applicants moved to levels 2, 3, 4, and 5.

Some embodiments of the present invention can provide one or more of the following functions for the Search Committee Chair, using, for example, a chair terminal 142 of FIG. 1:

17. Allow the System Administrator to designate one or more individuals as Search Committee Chair. Individuals designated as Search Committee Chair may have the same login procedure and password change procedure as function 6.

18. Allow all individual members designated as Search Committee Chair the same access to review applicant information and enter ratings as described in functions 7 through 16. Moreover, in some embodiments, the Search Committee Chair and/or the System Administrator can attach one or more additional documents to the applicant's online application.

19. When at the list of applicants at “Level 1”, or any other level, allows the Search Committee Chair to access the ratings entered by the Search Committee Members on all applicants at the current level (1, 2, 3, 4, or 5). To display the ratings entered by all Search Committee Members, the system builds a screen called “Consolidated Ratings”.

20. Build a screen called “Consolidated Ratings”, which displays a matrix for applicants at the current level. The matrix displays the applicants' sequence number and name in a left hand column (sorted by sequence number) and all Search Committee Members', Search Committee Chairs', and Interviewers' initials are in the uppermost row. The consolidated rating screen displays the rating (for example using X, /, O symbols) entered by any and all Search Committee Members, Search Committee Chairs, and Interviewers for any and all applicants. Furthermore, the consolidated ratings screen displays the total number of X rating scores, the total number of / rating scores, and the total number of O rating scores for each applicant in the rightmost columns. Other embodiments may also allow the Search Committee Chair to consolidate the comments from all Search Committee Chairs, Members and Interviewers. Yet other embodiments may also allow the Search Committee Chair and/or Member to access an applicant's online application directly from the consolidated ratings screen.

21. Allow the Search Committee Chair, when viewing the “consolidated ratings” screen, to print the page and download the matrix into, for example, an Excel spreadsheet.

22. Allow the Search Committee Chair to move any or all applicants to another level. It will be understood that Search Committees typically meet to discuss the applicants' qualifications and identify which applicants should be retained for further consideration. In large pools of applicants, there may be two or more cycles of refining the screening criteria so that a large pool of applicants is reduced to a manageable number (e.g. around 10-12) to allow for telephone interviews or face-to-face interviews. The “Applicant Level” screen appears and displays all applicants and their numeric level (1, 2, 3, 4, or 5). The Search Committee Chair selects a specific applicant by clicking on the applicant's name. A screen is then displayed that indicates the applicant's current level and allows the Search Committee Chair to select another level (1, 2, 3, 4, or 5) for that applicant. The Search Committee Chair selects the new level and presses an update button, which returns the Search Committee Chair to the “Applicant Level” screen, and displays the numeric level next to the applicant's name.

23. Allow the Search Committee Chair to download a dataset of all applicants. It will be understood that Search Committees typically analyze their applicant pools and send email messages and written correspondence. The downloaded data fields may be: Sequence number, the user ID entered by the applicant, the password entered by the applicant, system generated confirmation number, system assigned date of application, vacancy title, current level, applicant's last name, first name, middle initial, title, email address, phone number, alternate phone number, street address, city, state, zip code, country, confirmation and filename of attached letter, confirmation and file name of resume, confirmation and filename of references, title of current position, current employer, and dates of current position, title of former position, former employer, and dates of former employment, title of second former position, second former employer, and dates of second former employment, confirmation that information is complete, highest degree received and college or university awarding degree, next highest degree received and college or university awarding next highest degree, third highest degree received and college or university awarding third highest degree, other relevant credentials.

24. Allow the Search Committee Chair to develop a vacancy-specific email acknowledgement message, which overrides the default email message developed by the System Administrator, to be automatically sent to applicants who apply online. The Search Committee Chair may enter the following: Whom the message is from, the subject line, and the message content.

Some embodiments of the present invention can provide one or more of the following functions for the Interviewers, using, for example, an Interviewer terminal 146 of FIG. 1:

25. Allow Interviewers to enter the system (with an assigned user ID and password) and review applicant information. Individuals designated as Interviewers have the same login procedure and password change procedure as function 6.

26. For the Interviewer, display only the applicants who have reached Level 5.

27. From the list of all applicants at “Level 5”, allow the Interviewer to click on the applicant's name, which then displays Page 1 of the applicant's information. Page 1 displays the applicant's name, address, email address, two phone numbers, the applicant's three highest degrees, and additional credentials entered by the applicant.

28. From Page 1 of the applicant's information, allow the Interviewer to open Page 2 of the applicant's information. Page 2 displays the applicant's current and past two employers, and allows the Interviewer to open the documents submitted by the applicant. Page 2 also allows the Interviewer to evaluate the applicant as Highly Recommended, Moderately Recommended, or Not Recommended. Page 2 also allows the Interviewer to write in comments and opinions about the applicant's qualifications.

29. From Page 2 of the applicant's information, allow the Interviewer to view a summary of the applicant's information, and the rating score and comments entered by the Interviewer. The rating score of “Highly Recommended”, “Moderately Recommended”, and “Not Recommended” may be represented by the following symbols: “Highly Recommended”: X, “Moderately Recommended”: /, and “Not Recommended”: O.

30. From Page 2 of the applicant's information, allow the Interviewer to return to the list of applicants at “Level 5”. If the Interviewer has entered a rating score (X, /, or 0), the rating score is displayed next to the applicant's name.

31. When at the list of applicants at “Level 5”, allow the Interviewer to select another applicant and proceed through the process of reviewing and rating that applicant; or allow the Interviewer to select a applicant he/she has already rated and review that applicant's information again, and change the rating or comments that were previously entered on the applicant.

32. When at the list of applicants at “Level 5”, allow the Interviewer to logout of the system.

Some embodiments of the present invention can provide one or more of the following functions for the System Administrator, using, for example, a System Administrator terminal 120 of FIG. 1:

33. Allow one or more designated individuals to log in as the “System Administrator” with an account and password.

34. Display a list of all authorized users of the system to the System Administrator.

35. Allow the System Administrator to click on a user's name and display a profile of that user, to include the user's First Name, Middle Initial, Last Name, Phone Number, User's password, and vacancies for which the user has access.

36. Allow the System Administrator to authorize a user access to a specific vacancy, and remove access to a specific vacancy.

37. Allow the System Administrator to select the user's role or level of access (i.e. Search Committee Member, Interviewer, Search Committee Chair) for a specific vacancy.

38. Display a list of current vacancies (i.e. vacancy number, job title, and closing date) handled by the system.

39. Allow the System Administrator to add a vacancy by entering a vacancy number, job title, start date for the posting, closing date, type of position (Senior or Academic Officer, Faculty, or Staff), the option to blind carbon copy a committee member on any email acknowledgement messages sent to applicants, the email address of the blind carbon copy addressee, and the URL for the vacancy announcement.

40. Once the System Administrator has added a vacancy, allow the System Administrator to edit the vacancy's job title, start date for the posting, closing date, type of position (Senior or Academic Officer, Faculty, or Staff), the option to blind carbon copy a committee member on email acknowledgement messages sent to applicants, the email address of the blind carbon copy addressee, and the URL for the vacancy announcement.

41. Allow the System Administrator to download a dataset of all applicants for the vacancy. The data fields may be: sequence number, user id, password, system confirmation number, system assigned date of application, vacancy, current level, last name, first name, middle initial, title, email address, phone number, alternate phone number, street address, city, state, zip code, country, gender, ethnicity, veteran's status, confirmation and filename of attached letter, confirmation and file name of resume, confirmation and filename of references, title of current position, current employer, and dates of current position, title of former position, former employer, and dates of former employment, title of second former position, second former employer, and dates of second former employment, confirmation that information is complete, highest degree received and college or university awarding degree, next highest degree received and college or university awarding next highest degree, third highest degree received and college or university awarding third highest degree, other relevant credentials.

42. Allow the System Administrator and/or Search Committee Chair to archive the data from a vacancy.

43. Allow the System Administrator to change the System Administrator's password.

44. Allow the System Administrator to enter and/or modify the content of the default email acknowledgement message that is sent to applicants to confirm their electronic application materials were successfully received.

FIG. 2 is a functional block diagram of systems, methods and/or computer program products according to some embodiments of the present invention. Functionality of an applicant is indicated at Block 300 and may be implemented, at least in part, using, for example, an Applicant Terminal 130 of FIG. 1. Functionality of system administration is indicated at Block 400 and may be implemented, at least in part, using, for example, an Administrator Terminal 120 of FIG. 1. Functionality of application review and rating is indicated at Block 500 and may be implemented, at least in part, using, for example, the Chair, Member, and Interviewer Terminals 142, 144 and 146, respectively, of FIG. 1.

As shown in FIG. 2, in general, the Applicant functionality of Block 300 generally includes viewing a vacancy announcement 210, filling out an online application 220 and attaching documents 230 thereto. System administration functions of Block 400 generally include managing the vacancy 240, managing user accounts 250 and managing system passwords 260. Application review and rating functionality of Block 500 generally includes application review and ratings 270, and managing the data 280. Detailed operations for performing the functionality of Blocks 300, 400 and 500 of FIG. 2 now will be described according to various embodiments of the present invention. User interfaces that may be used according to some embodiments of the present invention also will be described.

Referring to FIG. 3, detailed operations for the applicant, which may correspond to Block 300 of FIG. 2, and which may use an applicant terminal 130 of FIG. 1, now will be described according to some embodiments of the present invention. It will be understood that, although the following operations may be described in terms of a “system”, analogous methods and computer program products also may be provided according to embodiments of the present invention.

Referring now to FIG. 3, an applicant interested in a position with the organization first sees the vacancy announcement online 301 and/or in print media. Either type of announcement can direct the applicant to use the Internet browser to open the HR Search system's list of vacancies 302. The system displays the titles of all active and closed vacancies 302 in the system. The applicant clicks on the title of the active vacancy of interest to initiate an online application. The applicant may click on the title of a “closed” vacancy. In this case, the applicant will be able to enter and modify only Page 1 of the online application 304.

The system initially requests the applicant to enter a self-produced identification word and password 303. In some embodiments, the password must be successfully repeated 303.1, 303.2 for the new applicant to proceed. Applicants who have previously entered the system will not have to repeat their password.

Once an ID and password are correctly entered 303, 303.1, and 303.2, the system displays Page 1 of the application 304. If an applicant logs in with a previously used ID and password, Page 1 (and subsequent pages) of the online application 304 will display the information previously entered by the Applicant. If the applicant is new to the system, Page 1 304 may require a job applicant to enter the following information: name, address, email address, and phone numbers.

The applicant moves to Page 2 305 on which the applicant may enter the following information concerning his/her three highest earned degrees: College Name, College City, State, Degree, Major, and Date. This page 305 allows the applicant to enter information on any related credentials or certifications. The applicant then clicks to the next page 306 where he/she is allowed to enter the following information on his/her current and previous two employers: Position, Employer, From date, and To date.

The system allows the applicant to attach the following three separate documents or files: letter of interest 307, resume 308, and list of references 309. Due to the importance of the letter and resume, the system warns 306.1 the applicant if he/she has not attached either document before moving to the next page 310. The applicant then clicks to the next page 310 where he/she is allowed to enter his/her gender, race, and eligibility for veteran's preference. The applicant then clicks to the next page 311 where information concerning the employment process is displayed. Also displayed within the information is the system-generated application number.

At this time, a system-generated email message 314 is sent to the applicant based on the email addressed entered on Page 1 of the application 304. The content of the default email message is determined by the System Administrator 406 and can be overwritten by the Search Committee Chair 602. This email message is also sent as a blind carbon copy to the addressee entered by the Search Committee Chair 408. From the information page 311 the applicant can view and print a summary 312 of the information he/she has entered on previous pages. The applicant can then choose to either logout and return to the main list of university vacancies 313, or return to the vacancies within the system 302.

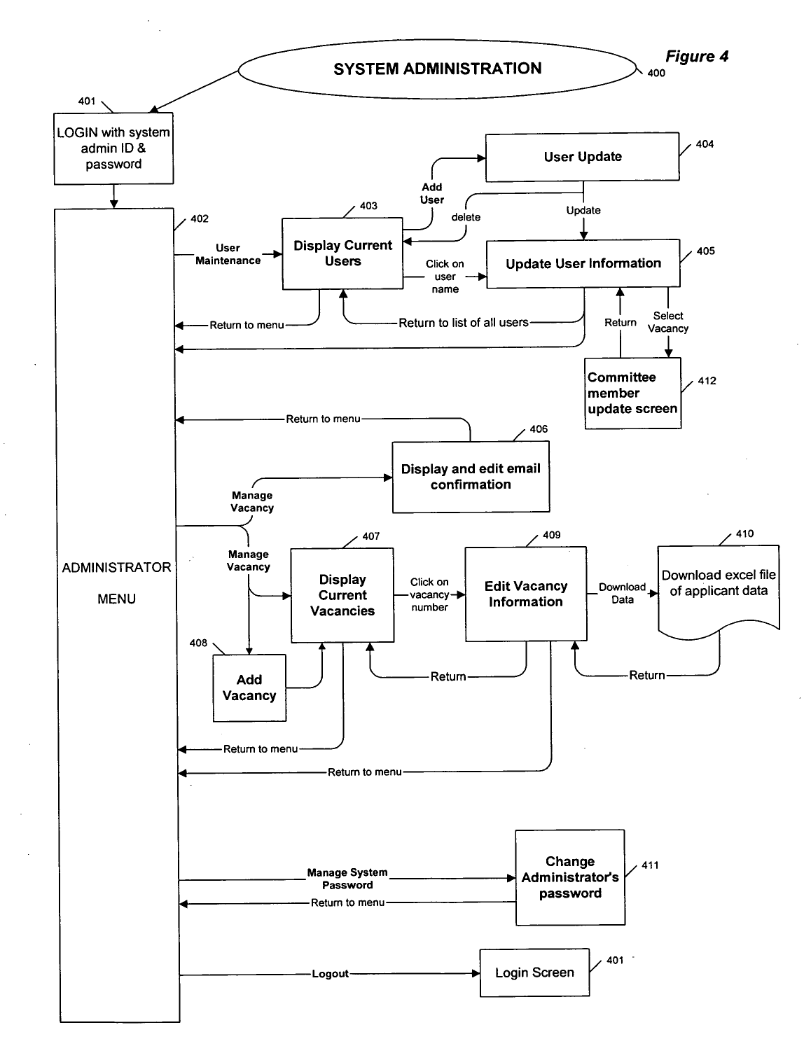

Referring to FIG. 4, detailed operations for the system administrator, which may correspond to Block 400 of FIG. 2, and which may use a system administrator terminal 120 of FIG. 1, now will be described according to some embodiments of the present invention. It will be understood that, although the following operations may be described in terms of a “system”, analogous methods and computer program products also may be provided according to embodiments of the present invention.

Referring now to FIG. 4, one ID and its associated password are designated for the “System Administrator” when some embodiments of the present invention are installed. When an individual logs on 401 as a System Administrator, the system displays a menu screen 402 that allows the System Administrator to do one or more of the following things: manage user accounts, manage vacancies, manage the system password, and configure the default email message.

If the System Administrator desires to manage user accounts, that option is selected, and a new screen 403 displays the last name, first name, initial, and logon ID of all current users of the system. If the System Administrator wants to add a user, that option is selected, and a new screen 404 is displayed. The System Administrator enters the following information to add a user to the system: Login Id, First Name, Middle Initial, Last Name, Phone, Password, Option to Reset Password, and option to activate.

Once a new user is added, the System Administrator can return to the display of users 403. When viewing the display of users 403, the System Administrator can edit information on a user. The System Administrator can click on a user's last name, which then displays the user update screen 405. This screen 405 shows user's First Name, Middle Initial, Last Name, Phone Number, User's password, and vacancies for which the user has access. The System Administrator can authorize a user to access a specific vacancy, and can remove access to a specific vacancy, and can delete users from the system. The System Administrator can select the user's role or level of access (i.e. Search Committee Member, Interviewer, Search Committee Chair) for a specific vacancy 412. The System Administrator can either return to the display of users 403 or return to the System Administrator's menu 402.

As part of managing a vacancy, the System Administrator's menu 402 allows the System Administrator to enter and modify the content of the default email confirmation message 406. The system automatically sends this email message 314 to applicants when they submit page 4 of their online applications 310. The Search Committee Chair, however, may adjust the content of the default email message content for specific vacancies 602. The System Administrator may also change the content and aspects of the system's vacancy listing 302. If the System Administrator desires to manage a vacancy, that item is selected from the main menu 402. A new screen 407 displays a list of current vacancies (i.e. Vacancy number, job title, and closing date) previously entered by the System Administrator.

The System Administrator can add a vacancy by selecting the menu item and displaying the New Vacancy screen 408. The System Administrator enters one or more of the following information to add a vacancy: job title, start date for the posting, closing date, type of position (i.e. Senior or Academic Officer, Faculty, or Staff), the option to blind carbon copy a committee member on any automatic email acknowledgement messages sent to applicants, the email address of the blind carbon copy addressee, and the URL for the vacancy announcement. Once the System Administrator has added a vacancy 408, the system moves to the current vacancies screen 407. When on the current vacancies screen 407, the System Administrator can edit information on any specific vacancy by clicking on that vacancy's number. Clicking on the vacancy number causes the Edit Vacancy screen 409 to appear, which allows the System Administrator to change the vacancy's job title, start date for the posting, closing date, type of position (Senior or Academic Officer, Faculty, or Staff), the option to blind carbon copy a committee member on email confirmation messages 314 sent to applicants, the email address of the blind carbon copy addressee, and the URL for the vacancy announcement 301.

The System Administrator can download a dataset of all applicants for the vacancy. This enables the System Administrator to see the race, sex, and veteran's status of each applicant, which facilitates analysis of applicants through the selection process. The System Administrator can save this dataset to his/her computer. Clicking on “Download Dataset” on the Edit Vacancy Info screen 409 launches a spreadsheet, such as MS Excel, and delivers data on all applicants for a specific vacancy in an Excel file 410. The following data may be downloaded in the following fields: sequence number, user id, password, system confirmation number, system assigned date of application, vacancy, current level, last name, first name, middle initial, title, email address, phone number, alternate phone number, street address, city, state, zip code, country, gender, ethnicity, veteran's status, confirmation and filename of attached letter, confirmation and file name of resume, confirmation and filename of references, title of current position, current employer, and dates of current position, title of former position, former employer, and dates of former employment, title of second former position, second former employer, and dates of second former employment, confirmation that information is complete, highest degree received and college or university awarding degree, next highest degree received and college or university awarding next highest degree, third highest degree received and college or university awarding third highest degree, other relevant credentials.

The System Administrator may change the System Administrator's password by selecting that option on the menu 402. The Change Password screen 411 is displayed, in which the System Administrator can change the System Administrator's password and then return to the menu 402. The System Administrator may log out and return to the system login screen 401.

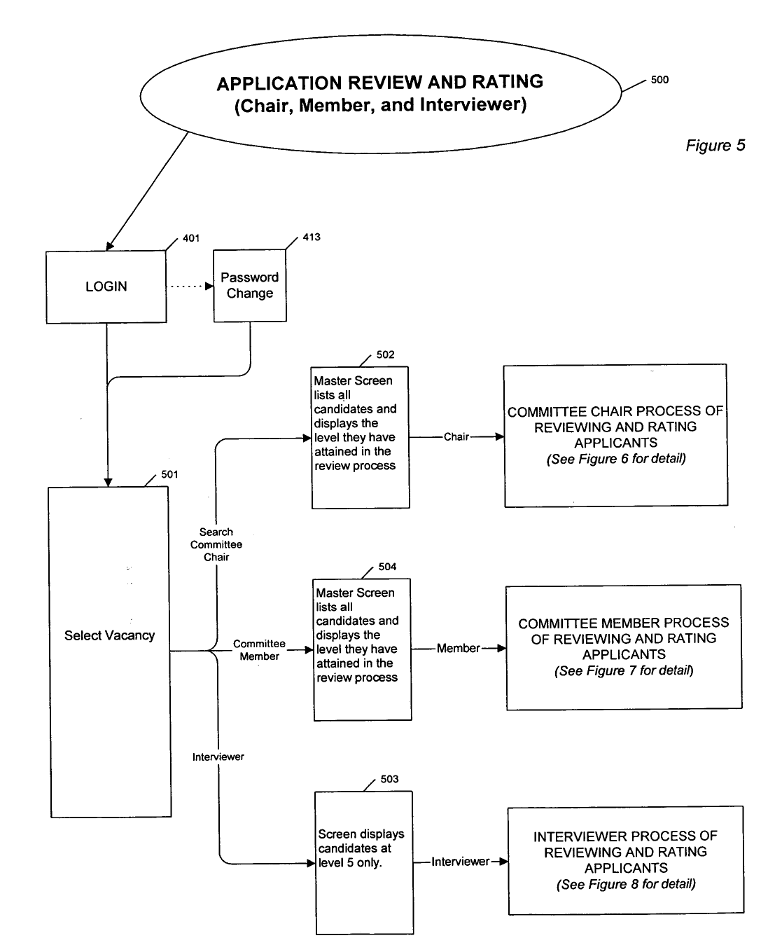

Referring to FIG. 5, detailed operations for the Application Review and Rating, which may correspond to Block 500 of FIG. 2, and which may use Search Committee terminals 140 of FIG. 1, now will be described according to some embodiments of the present invention. It will be understood that, although the following operations may be described in terms of a “system”, analogous methods and computer program products also may be provided according to embodiments of the present invention.

Referring now to FIG. 5, participants on a Search Committee can be designated in the system as either Search Committee Chair, Search Committee Member, or Search Committee Interviewer, which allows different participants to have different levels of access to information on the applicants. Each Search Committee participant first logs into the system 401 with a login ID and password issued by the system administrator. The system then recognizes the level of access associated with the login ID and password. When a participant first logs in, the system displays all vacancies 501 for which he/she has been granted access. The participant then selects the vacancy for which he/she wants to see the applications.

If the individual who has logged in is a Search Committee Chair for that vacancy, the system displays a master screen 502 that shows the names of all applicants and a sequence number in the order in which their electronic applications were received. The system displays this information in a matrix format, such that the sequence number and names are in the left-most columns. Five additional columns (labeled “Level 1”, “Level 2”, “Level 3”, “Level 4”, and “Level 5”) to the right display the level to which each applicant has attained in the selection process by showing a bar moving through the columns. Some embodiments of the invention support the Search Committee process of narrowing the initial applicant pool into smaller and smaller pools, until a small enough pool is identified to allow for interviews. To review the applications at a certain level, Search Committee participants designated as either the Search Committee Chair or Search Committee Member select the level of interest and the system next displays the applicants who have been moved to that level. The Search Committee Chair can then review the online applications and rate the applicants at the selected level.

If the individual who has logged in is a Search Committee Member for that vacancy, the system displays a master screen 504 that shows the names of all applicants and a sequence number in the order in which their electronic applications were received. In some embodiments of the invention, the system displays this information in a matrix format, such that the sequence number and names are in the left-most columns. Five additional columns (labeled “Level 1”, “Level 2”, “Level 3”, “Level 4”, and “Level 5”) to the right display the level to which each applicant has attained in the selection process by showing a bar moving through the columns. Some embodiments of the invention can support the Search Committee process of narrowing the initial applicant pool into smaller and smaller pools, until a small enough pool is identified to allow for interviews. To review the applications at a certain level, Search Committee participants designated as either the chair or member select the level of interest and the system next displays the applicants who have been moved to that level. The Search Committee Member can then review the online applications and rate the applicants at the selected level.

If the individual who has logged in is a Search Committee Interviewer for that vacancy, then the system displays only applicants who have been moved to level 5 503. The Search Committee Interviewer is then presented information that will allow him/her to review and rate the applicants at level 5

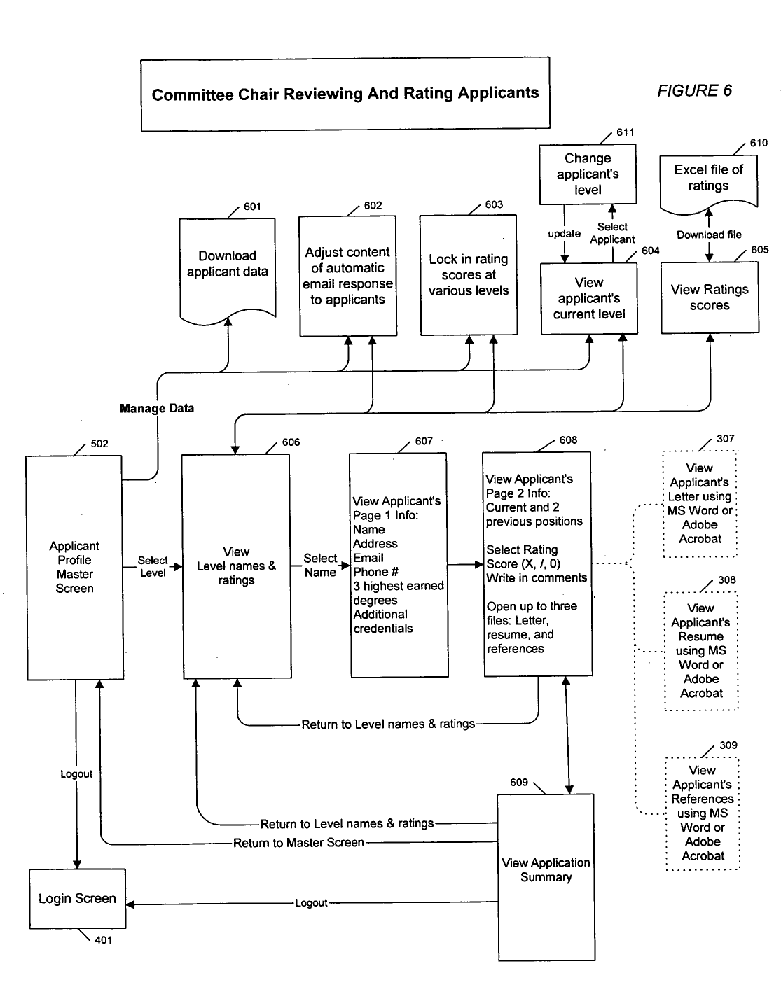

Referring to FIG. 6, detailed operations for the Search Committee Chair, which may correspond to Block 500 of FIG. 2, and which may use a Committee Chair terminal 142 of FIG. 1, now will be described according to some embodiments of the present invention. It will be understood that, although the following operations may be described in terms of a “system”, analogous methods and computer program products also may be provided according to embodiments of the present invention.

Referring now to FIG. 6, at this point, the Search Committee Chair has already logged in 401, selected the vacancy of interest 501, and viewed the master screen of all applicants for the vacancy 502.

From the Applicant Profile Master screen 502 the Search Committee Chair can download a spreadsheet, such as an Excel file, of all applicants for that vacancy 601. The downloaded data fields may be: Sequence number, the user ID entered by the applicant, the password entered by the applicant, system generated confirmation number, system assigned date of application, vacancy title, current level, applicant's last name, first name, middle initial, title, email address, phone number, alternate phone number, street address, city, state, zip code, Country, confirmation and filename of attached letter, confirmation and file name of Resume, confirmation and filename of references, title of current position, current employer, and dates of current position, title of former position, former employer, and dates of former employment, title of second former position, second former employer, and dates of second former employment, confirmation that information is complete, highest degree received and college or university awarding degree, next highest degree received and college or university awarding next highest degree, third highest degree received and college or university awarding third highest degree, other relevant credentials.

On the edit screen 602, the Search Committee Chair can edit the content of the email confirmation message 314, which is automatically sent to applicants who apply online. The chair may enter the following: Whom the message is from, the subject line, and the message content. The content of the email message will overwrite, for this specific vacancy, the default email message content 406 entered by the System Administrator.

The Search Committee Chair can lock the rating scores at various levels 603. Once the Search Committee Chair has moved applicants to a higher level (2 through 5) 611, the Search Committee Chair can lock the rating scores at all previous levels.

The Search Committee Chair can move applicants to other levels 604. The Search Committee Chair selects a specific applicant by clicking on the applicant's name. A screen is then displayed that indicates the applicant's current level and allows the chair to select another level (1, 2, 3, 4, or 5) for that applicant. The Chair selects the new level and presses an update button, which returns the chair to the “Applicant Level” screen, and displays the numeric level next to the applicant's name. Moving certain applicants to higher levels facilitates the common Search Committee process of successive reviews of applicants to narrow a broad pool of applicants into a smaller number who can be invited for interviews.

The Search Committee Chair can select any level (1 through 5) and the system displays a list of all applicants 606 (sequence number, name, and the Chair's rating of that applicant) at that level. When at a specific level, the Search Committee Chair can view the ratings entered by all committee chairs, members, and interviewers for applicants on that level. To display the ratings entered by all committee participants, the system builds a screen 605 called “Consolidated Ratings”, which displays a matrix for applicants at that level in which the applicants' sequence number and name are displayed in a left hand column (sorted by sequence number) and all committee members' initials are in the uppermost row. The consolidated rating screen displays the rating (using X, /, O symbols) entered by any and all committee Chairs, members and interviewers for any and all applicants. Furthermore, the consolidated ratings screen displays the total number of X ratings , the total number of / ratings, and the total number of O ratings for each applicant in the rightmost columns. The Search Committee Chair, when viewing the “consolidated ratings” screen, can print the page and download the matrix into an excel spreadsheet 610.

The Search Committee Chair can select any level (1 through 5) and the system displays a list of all applicants 606 (sequence number, name, and the Search Committee Chair's rating of that applicant) at that level. To view a specific application, the Search Committee Chair clicks on the applicant's name.

The system then displays the first of two pages of the applicant's information. Page 1 607 may display the applicant's name, address, email address, two phone numbers, the applicant's three highest degrees, and additional credentials entered by the applicant.

The Search Committee Chair can then open Page 2 of the applicant's information. Page 2 608 may display the applicant's current and past two employers, and allows the Search Committee Member to open the documents submitted by the applicant. Page 2 608 also allows the Search Committee Member to evaluate the applicant as Highly Recommended, Moderately Recommended, or Not Recommended. Page 2 608 also allows the Search Committee Chair to write in comments and opinions about the applicant's qualifications. At this point, the Search Committee Chair can return to the list of applicants at the current level 606. If the Search Committee Chair has entered a rating score (X, /, or 0), the rating score is displayed next to the applicant's name.

On Page 2 of the application 608, the Search Committee Chair may open the applicant's letter of interest 307. The system automatically launches MS Word, Adobe Acrobat and/or another application, and the letter 307 is then read as a normal document running under that application.

On Page 2 of the application 608, the Search Committee Chair may open the applicant's resume 308. The system automatically launches MS Word, Adobe Acrobat and/or another application, and the resume 308 is then read as a normal document running under that application.

On Page 2 of the application 608, the Search Committee Chair may open the applicant's list of references 309. The system automatically launches either MS Word or Adobe Acrobat, and the list of references 309 is then read as a normal document running under that application.

The Search Committee Chair can open and print a screen of a summary of the applicant's information 609, and the evaluation and comments entered by the Search Committee Chair. The evaluation of Highly Recommended, Moderately Recommended, and Not Recommended are represented by the following symbols:

Highly Recommended (X), Moderately Recommended (/) and Not Recommended (O).

The Search Committee Chair can logout of the system and will be returned to the Committee Member Login screen 401.

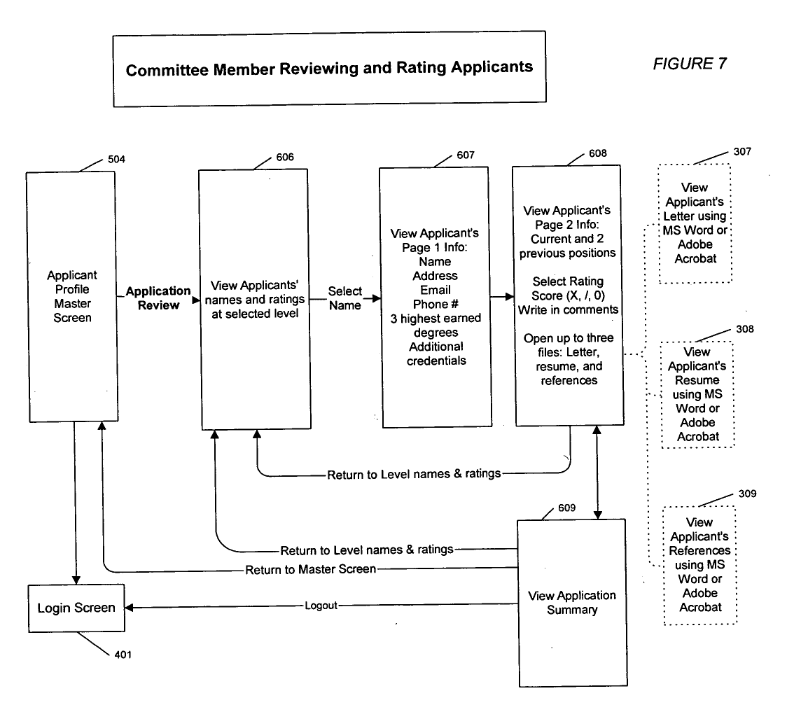

Referring to FIG. 7, detailed operations for the Committee Members, which may correspond to Block 500 of FIG. 2, and which may use a Member terminal 144 of FIG. 1, now will be described according to some embodiments of the present invention. It will be understood that, although the following operations may be described in terms of a “system”, analogous methods and computer program products also may be provided according to embodiments of the present invention.

Referring now to FIG. 7, at this point, the Search Committee Member has already logged in 401, selected the vacancy of interest 501, and viewed the master screen of all applicants for that vacancy 504.

The Search Committee Member can select any level (1 through 5) and the system displays a list of all applicants 606 (sequence number, name, and the Search Committee Member's rating of that applicant) at that level. To view a specific application, the Search Committee Member clicks on the applicant's name.

The system then displays the first pages of the applicant's online application. Page 1 607 displays the applicant's name, address, email address, two phone numbers, the applicant's three highest degrees, and additional credentials entered by the applicant.

The Search Committee Member can then open Page 2 of the applicant's information. Page 2 608 displays the applicant's current and past two employers, and allows the Search Committee Member to open the documents 306, 307, 308 submitted by the applicant. Page 2 608 also allows the Search Committee Member to evaluate the applicant as Highly Recommended, Moderately Recommended, or Not Recommended. Page 2 608 also allows the Search Committee Member to write in comments and opinions about the applicant's qualifications. On Page 2 of the application 608, the Search Committee Member may open the applicant's letter of interest 307. The system automatically launches MS Word, Adobe Acrobat and/or another application, and the letter 307 is then read as a normal document running under that application.

On Page 2 of the application 608, the Search Committee Member may open the applicant's resume 308. The system automatically launches MS Word, Adobe Acrobat and/or another application, and the resume 308 is then read as a normal document running under that application.

On Page 2 of the application 608, the Search Committee Member may open the applicant's list of references 309. The system automatically launches MS Word, Adobe Acrobat and/or another application, and the list of references 309 is then read as a normal document running under that application.

The Search Committee Member can open a screen to view a summary of the applicant's information 609, and the evaluation and comments entered by the Search Committee Member. The evaluation of Highly Recommended, Moderately Recommended, and Not Recommended are represented by the following symbols: Highly Recommended (X), Moderately Recommended (/) and Not Recommended (O).

At this point, the Search Committee Member can return to the list of applicants at the current level 606. If the Search Committee Member has entered a rating score (X, /, or 0), the rating score is displayed next to the applicant's name.

The Search Committee Member can logout of the system and will be returned to the Committee Member Login screen 401.

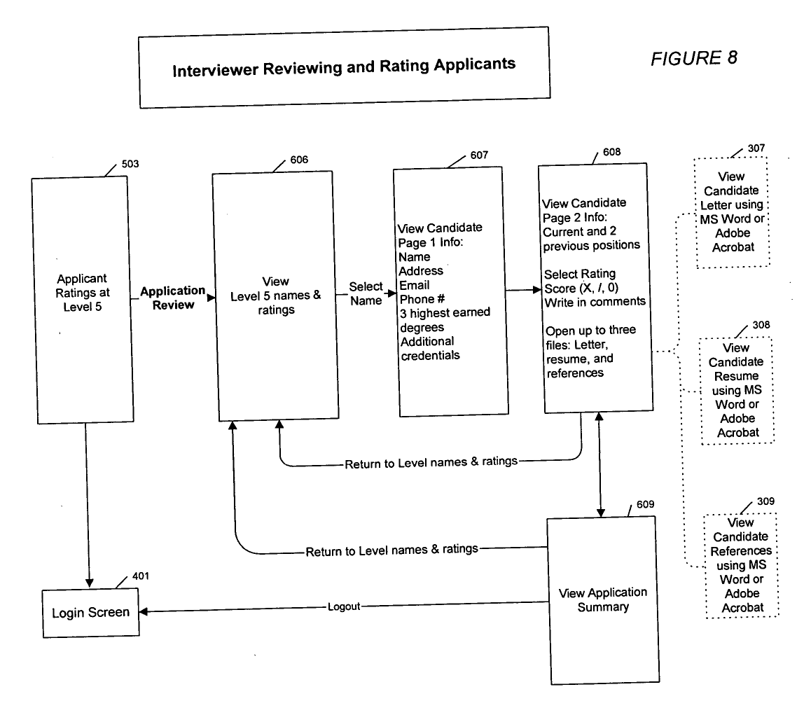

Referring to FIG. 8, detailed operations for the Interviewer, which may correspond to Block 500 of FIG. 2, and which may use an Interviewer terminal 146 of FIG. 1, now will be described according to some embodiments of the present invention. It will be understood that, although the following operations may be described in terms of a “system”, analogous methods and computer program products also may be provided according to embodiments of the present invention.

Referring now to FIG. 8, at this point, the Interviewer has already logged in 401, selected the vacancy of interest 501, and the system displays applicants at level 5 only 503.

The system displays only applicants at level 5 503 to the Interviewer. This display shows the sequence number, applicant's name, and the Interviewer's rating of that applicant. To view a specific application, the Interviewer clicks on the applicant's name.

The system then displays the first of two pages of the applicant's information. Page 1 607 displays the applicant's name, address, email address, two phone numbers, the applicant's three highest degrees, and additional credentials entered by the applicant.

The Interviewer can then open Page 2 of the applicant's information 608. Page 2 608 displays the applicant's current and past two employers, and allows the Interviewer to open the documents 306, 307, 308 submitted by the applicant. Page 2 608 also allows the Interviewer to evaluate the applicant as Highly Recommended, Moderately Recommended, or Not Recommended. Page 2 608 also allows the Interviewer to write in comments and opinions about the applicant's qualifications. On Page 2 of the application 608, the Interviewer may open the applicant's letter of interest 307. The system automatically launches MS Word, Adobe Acrobat and/or another application, and the letter 307 is then read as a normal document running under that application.

On Page 2 of the application 608, the Interviewer may open the applicant's resume 308. The system automatically launches either MS Word, Adobe Acrobat and/or another application, and the resume 308 is then read as a normal document running under that application.

On Page 2 of the application 608, the Interviewer may open the applicant's list of references 309. The system automatically launches MS Word, Adobe Acrobat and/or another application, and the list of references 309 is then read as a normal document running under that application.

The Interviewer can open a screen to view a summary of the applicant's information 609, and the evaluation rating and comments entered by the Interviewer. The evaluation of Highly Recommended, Moderately Recommended, and Not Recommended are represented by the following symbols: Highly Recommended (X), Moderately Recommended (/) and Not Recommended (O).

At this point, the Interviewer can return to the list of applicants at level 5 503. If the Interviewer has entered a rating score (X, /, or 0), the rating score is displayed next to the applicant's name.

The Interviewer can logout of the system and will be returned to the Committee Member Login screen 401.

Detailed embodiments of user interfaces that may be used with various embodiments of the present invention now will be described. It will be understood that these user interfaces include copyrightable material and/or trademarks of the assignee of the present invention. This copyrightable material and/or trademarks may be reproduced along with copies of the present application, but may not be used for any other purposes. Moreover, the user interfaces, also referred to as screens, contain names, positions and/or other identifications which are fictitious and are merely used for illustration. The assignee of the present application will be referred to herein as The University of North Carolina at Wilmington, UNC Wilmington or UNCW. Embodiments of the present invention will sometimes be referred to in the user interfaces as HRsearch. It will be understood that these names are merely illustrative and that other names may be used.

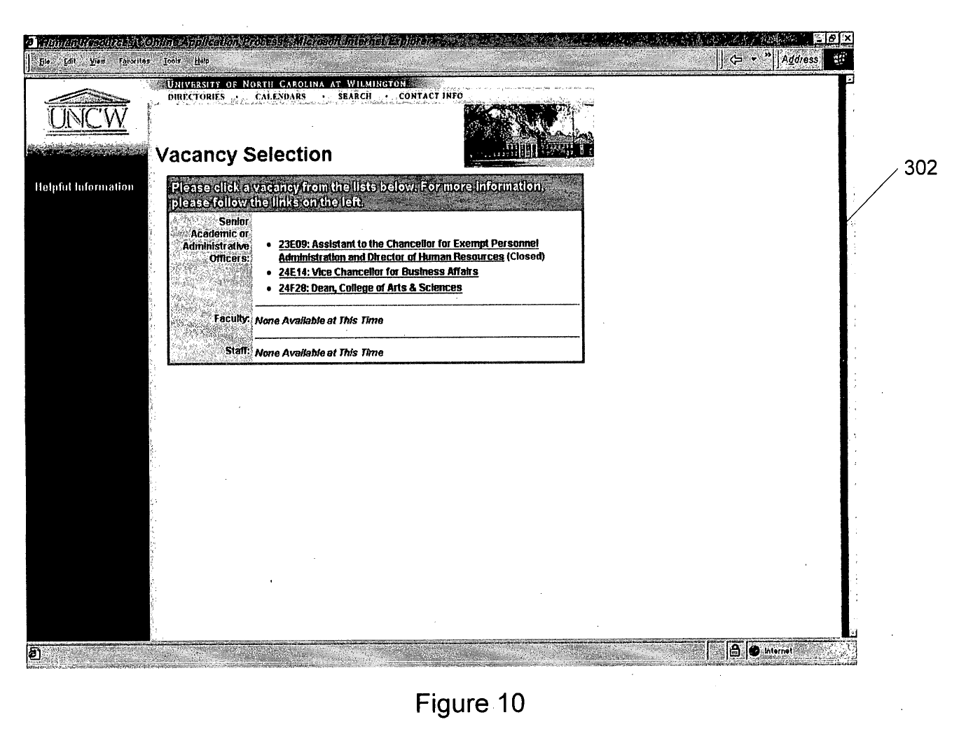

FIG. 9 illustrates a Vacancy Announcement screen (301). This vacancy announcement is on the UNCW's Human Resources web pages. It contains a hyperlink (not shown) to the Vacancy Selection Screen (302) illustrated in FIG. 10.

A web version of the vacancy announcement is not required. If one is established, however, the System Administrator enters the URL for it on the Edit Vacancy Info screen (409), and it also becomes the same web page used to generate the Vacancy Announcement pop-up window (316).

The Vacancy Selection screen (302) is presented to applicants and displays all the vacancies entered by the System Administrator in the HRsearch system.

The applicant may view the Helpful Information pop-up window (315) by clicking on the “Helpful Information” link in the left sidebar.

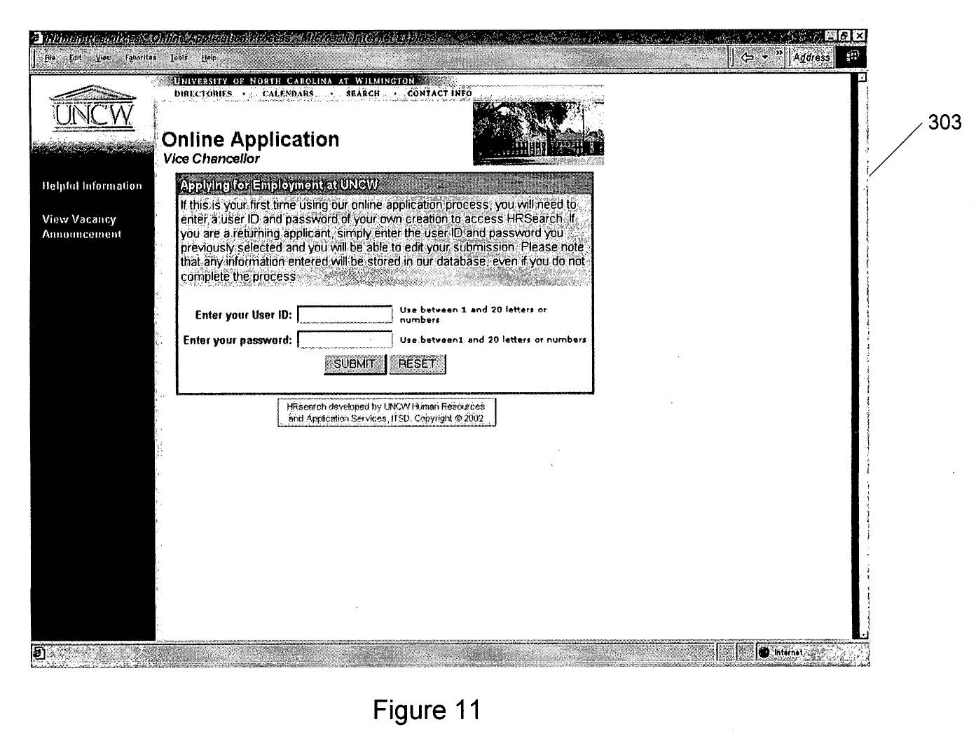

To begin an online application, an applicant clicks on the vacancy of interest. The system then displays the Online Application—Login screen (303) (FIG. 11).

If the application deadline has passed, the “(Closed)” will appear to the right of the vacancy title. If the application deadline has passed, an applicant may still enter and modify information only on Page 1 of the Online Application (304), and will then be returned to the Vacancy Selection screen (302). The System Administrator enters the deadline date on the New Vacancy screen (408).

To start the online application, the applicant creates his/her own User ID and enters it in the box. The applicant then creates his/her own password and enters it in the box.

The applicant may view the Vacancy Announcement pop-up window (316) by clicking on the “View Vacancy Announcement” link in the left sidebar.

The applicant may view Helpful Information pop-up window (315) by clicking on the “Helpful Information” link in the left sidebar.

The applicant may press the 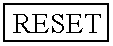
button to clear the two boxes and enter new information.

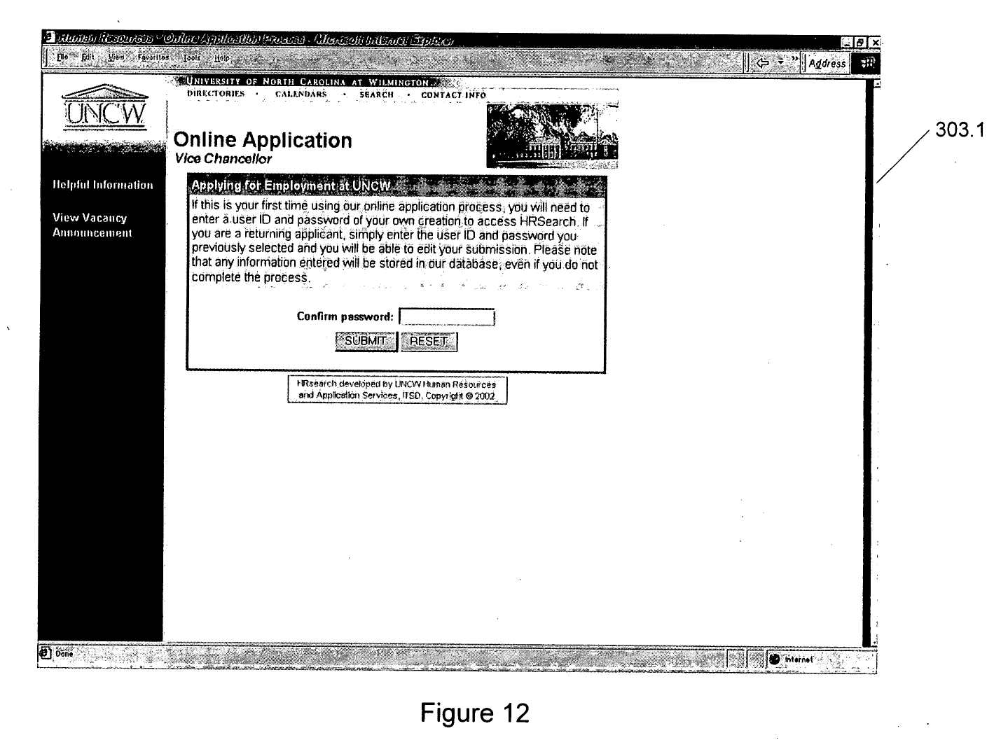

The applicant presses the 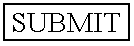
button after entering the ID and Password. If the system recognizes the ID and its matching password (meaning that the applicant has previously entered them) then the system retrieves the applicant's previously entered information and displays it on Page 1 of the Online Application (304). If the system does not recognize the ID and Password, then the system assumes the applicant is a new user and next displays a screen (303.1) (FIG. 12) for the applicant to validate the password. If the system recognizes the ID but not the password, the system will ask the applicant to re-enter the correct password.

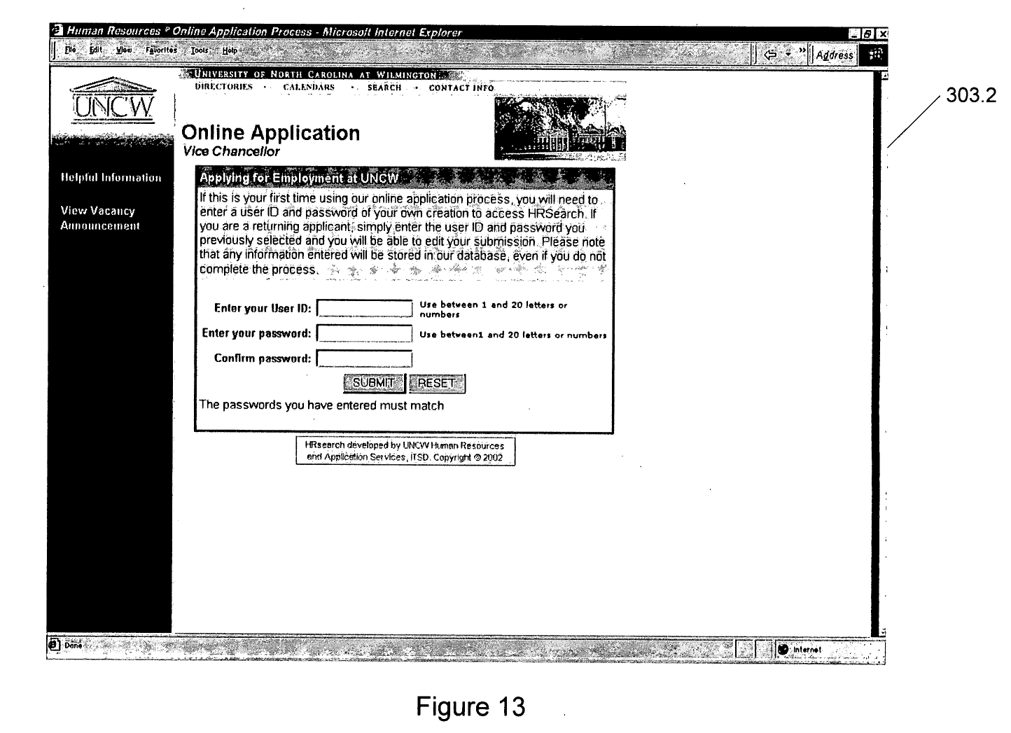

If the system does not recognize the ID and Password entered by the applicant on the Online Application—Login screen (303), then the system displays this screen. The applicant must type in the same password he/she entered on the Online Application—Login screen (303). When the applicant presses 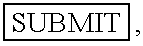
the system compares the two passwords. If the passwords match, the system displays Page 1 of the online application (304). It the passwords do not match, the system displays a screen (303.2), illustrated in FIG. 13, to ask the user to reenter both passwords.

The applicant may view the Vacancy Announcement pop-up window (316) by clicking on the “View Vacancy Announcement” link in the left sidebar.

The applicant may view Helpful Information pop-up window (315) by clicking on the “Helpful Information” link in the left sidebar.

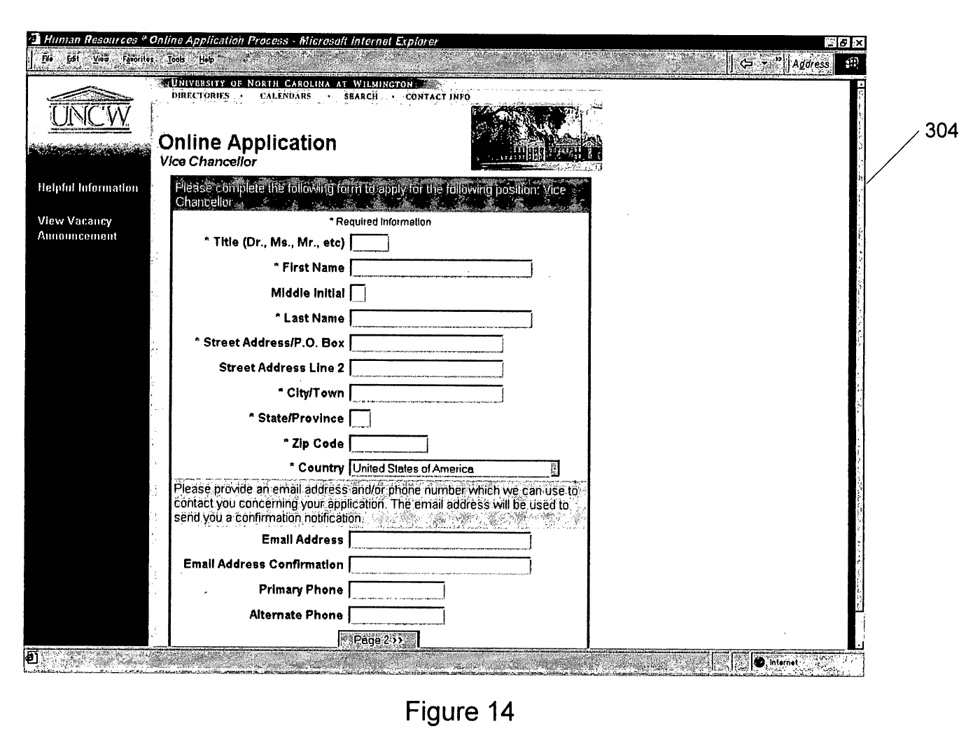

The screen of FIG. 13 is displayed if the passwords entered by the applicant in the login screens (303 and 303.1) do not match. On this screen, the applicant is given multiple opportunities to enter both passwords. When the applicant presses 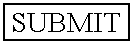
and both passwords match, the system will display Page 1 of the online application (304) illustrated in FIG. 14.

The applicant may press the 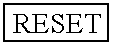
button to clear the boxes and enter new information.

The applicant may view the Vacancy Announcement pop-up window (316) by clicking on the “View Vacancy Announcement” link in the left sidebar.

The applicant may view Helpful Information pop-up window (315) by clicking on the “Helpful Information” link in the left sidebar.

The first screen of the online application (FIG. 14) asks the applicant to enter his/her title, first name, middle initial, last name, street address, city, state, zip code and country. Required fields are identified with an asterisk. The applicant is next asked to enter his/her email address, email address confirmation, and two telephone numbers.

The applicant may view the Vacancy Announcement pop-up window (316) by clicking on the “View Vacancy Announcement” link in the left sidebar. The applicant may view the Helpful Information pop-up window (315) by clicking on the “Helpful Information” link in the left sidebar.

The applicant presses the 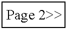
button to move to the next screen. At this time, the system checks to see if all required name and address fields have been filled out and will ask the applicant to complete any fields left blank. The system also checks to see if the email address and the email address confirmation are the same, and if not, will ask the applicant to correct either field.

If the vacancy is “closed” then a 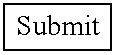
button will replace the 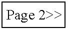
button. When the applicant presses 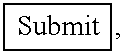
the changes are saved and the system displays the Vacancy Selection screen (302).

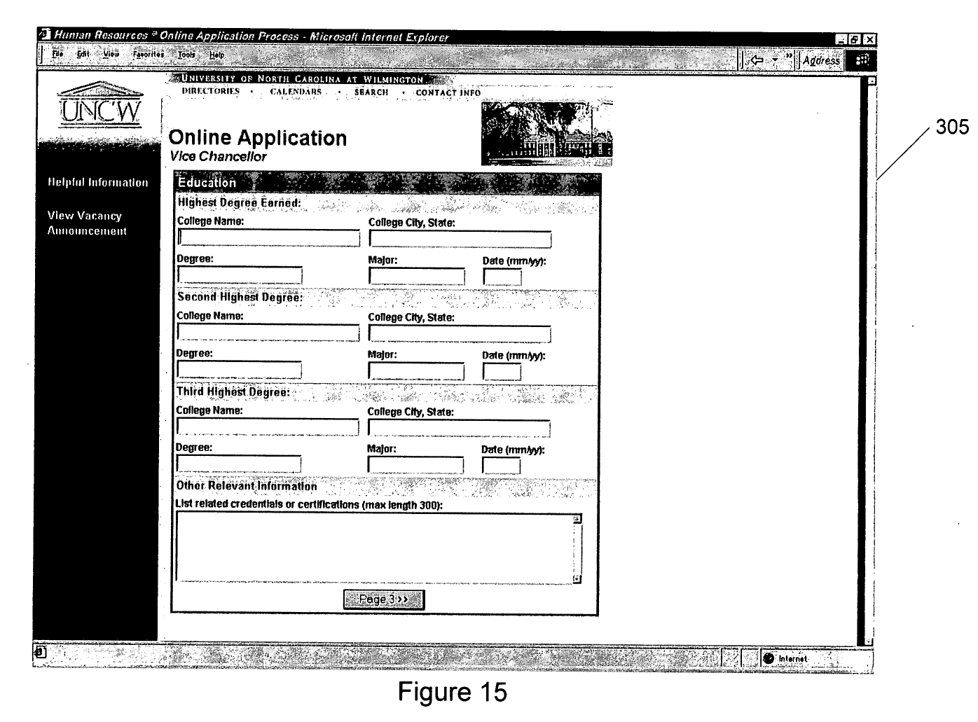

Screen 2 (305) of the online application is illustrated in FIG. 15, and requests that the applicant enter the college name, city, state, degree, major and date of the three highest earned degrees. The applicant may also provide additional. information regarding his/her credentials and certifications that relate to the vacancy.

The applicant may view the Vacancy Announcement pop-up window (316) by clicking on the “View Vacancy Announcement” link in the left sidebar. The applicant may view the Helpful Information pop-up window (315) by clicking on the “Helpful Information” link in the left sidebar.

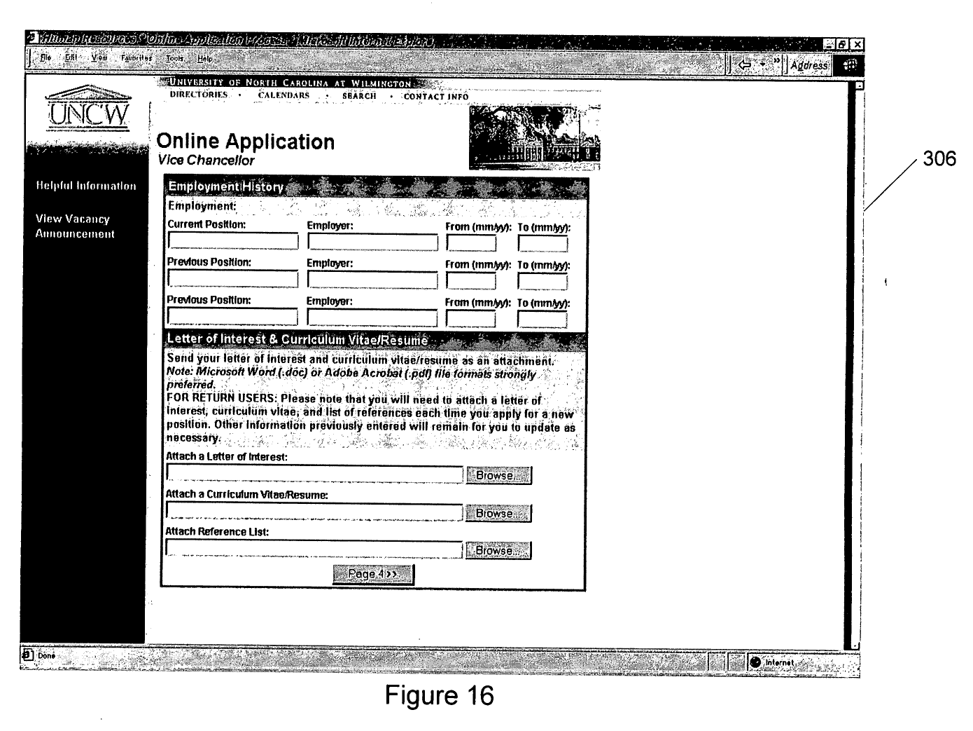

The applicant presses the 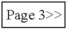
button to move to page 3 of the online application (306) illustrated in FIG. 16.

This screen asks the applicant to complete the position title, employer, and dates of his/her current and past two employers.

The applicant may then attach three documents, which are typically a letter of interest, resume, and list of references. It may be desirable for the attached files to be either MS Word (.doc) or Adobe Acrobat (.pdf). Another other file type may be less desirable to display to the Search Committee Members when reviewing the applicant's materials, but may be used in some embodiments. The applicant can use the 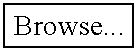
button to search the files of his/her computer or directory, and attach the files in that manner.

The applicant may view the Vacancy Announcement pop-up window (316) by clicking on the “View Vacancy Announcement” link in the left sidebar. The applicant may view the Helpful Information pop-up window (315) by clicking on the “Helpful Information” link in the left sidebar.

The applicant presses the 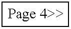
button when all information has been entered. If all information has been entered, the system displays page 4 of the online application (310). If either a Resume or Cover Letter file has not been attached, the system displays a warning (306.1).

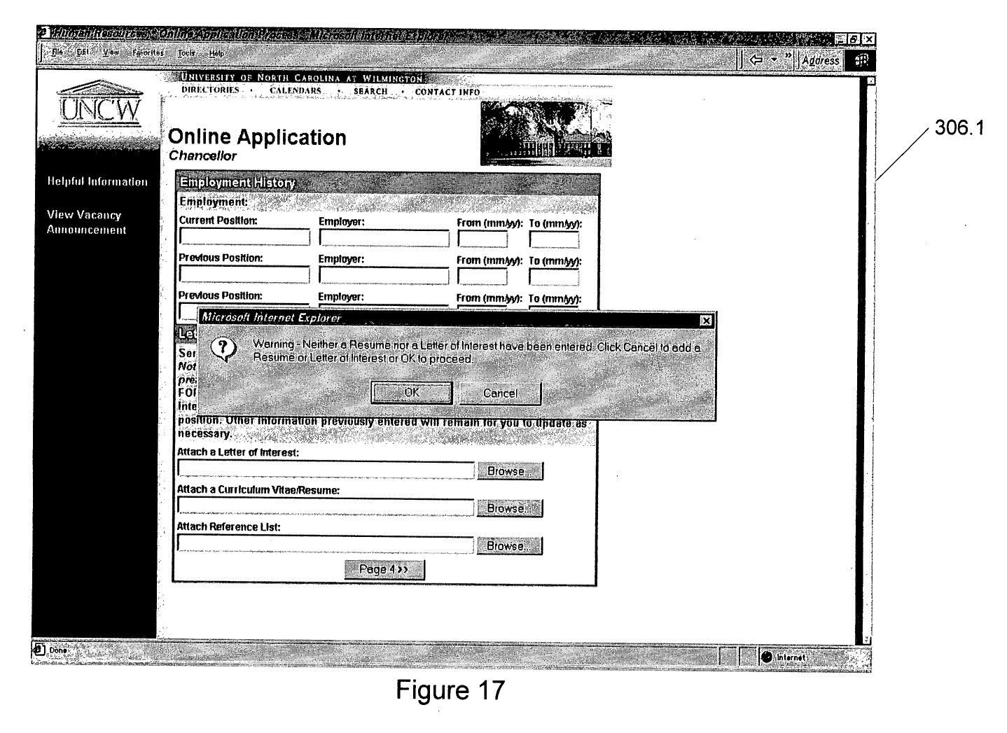

The pop-up window of FIG. 17 is displayed if the applicant presses 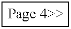
on page 3 of the online application (306) and has not attached either a resume or letter.

If the applicant presses 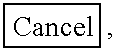
the system removes the pop-up window (306.1) as illustrated in FIG. 17, and continues to display Page 3 of the online application (306).

If the applicant presses 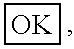
the system removes the pop-up window (306.1) and displays Page 4 of the online application (310).

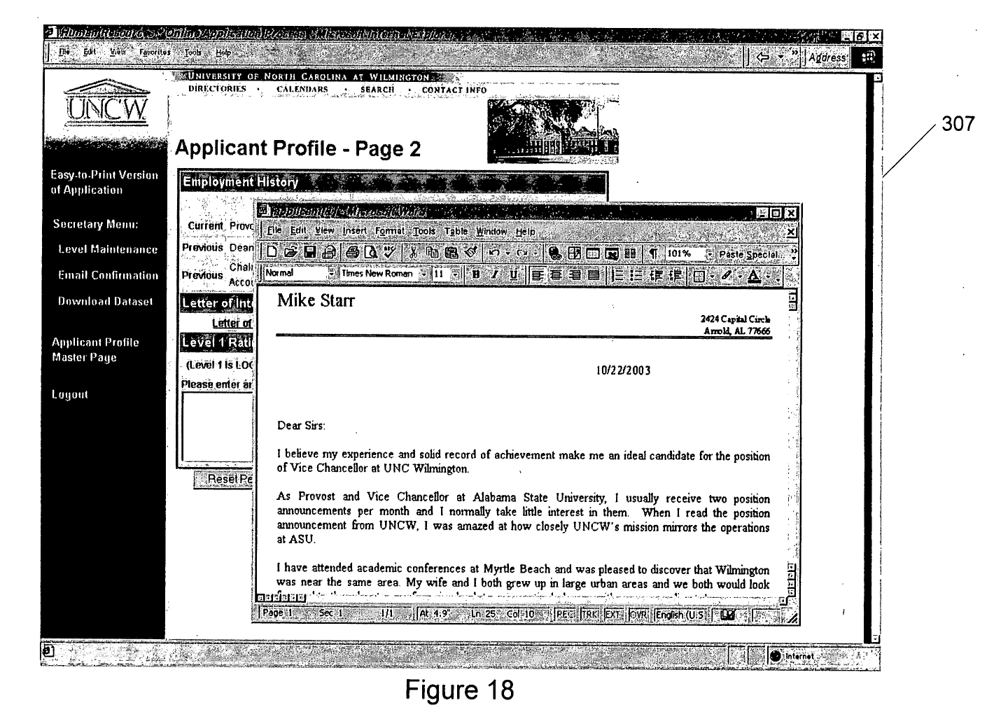

Applicant's letter of interest 307 is illustrated in FIG. 18. The system launches MS Word, Adobe Acrobat and/or another application to display the file attached by the applicant.

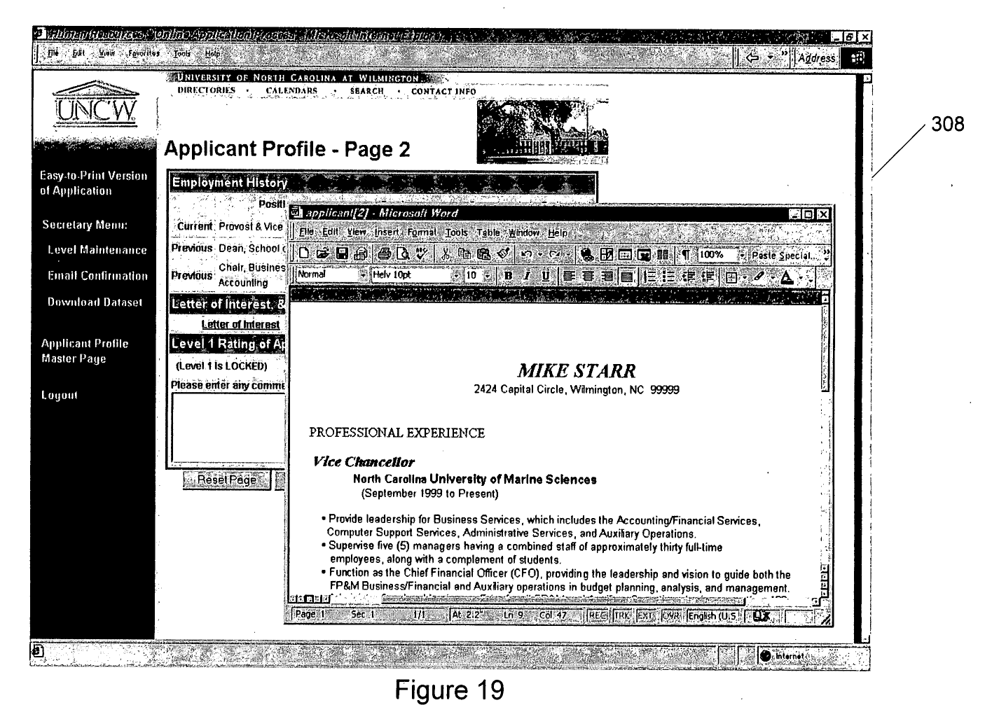

Applicant's resume 308 is illustrated in FIG. 19. The system launches MS Word, Adobe Acrobat and/or another application to display the file attached by the applicant.

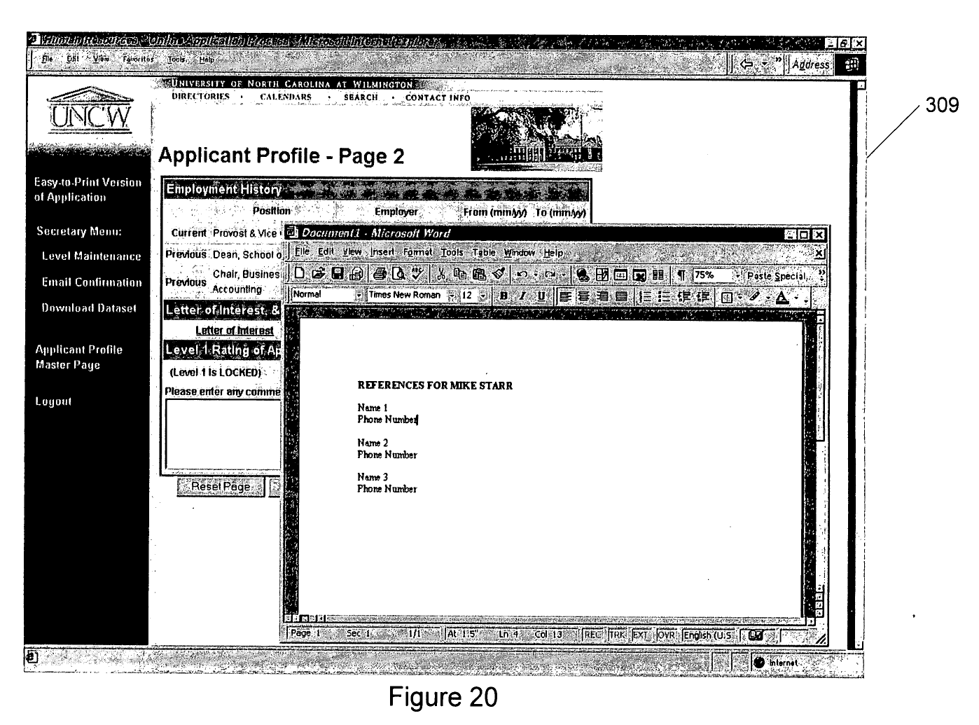

Applicant's references 309 are illustrated in FIG. 20. The system launches MS Word, Adobe Acrobat and/or another application to display the file attached by the applicant.

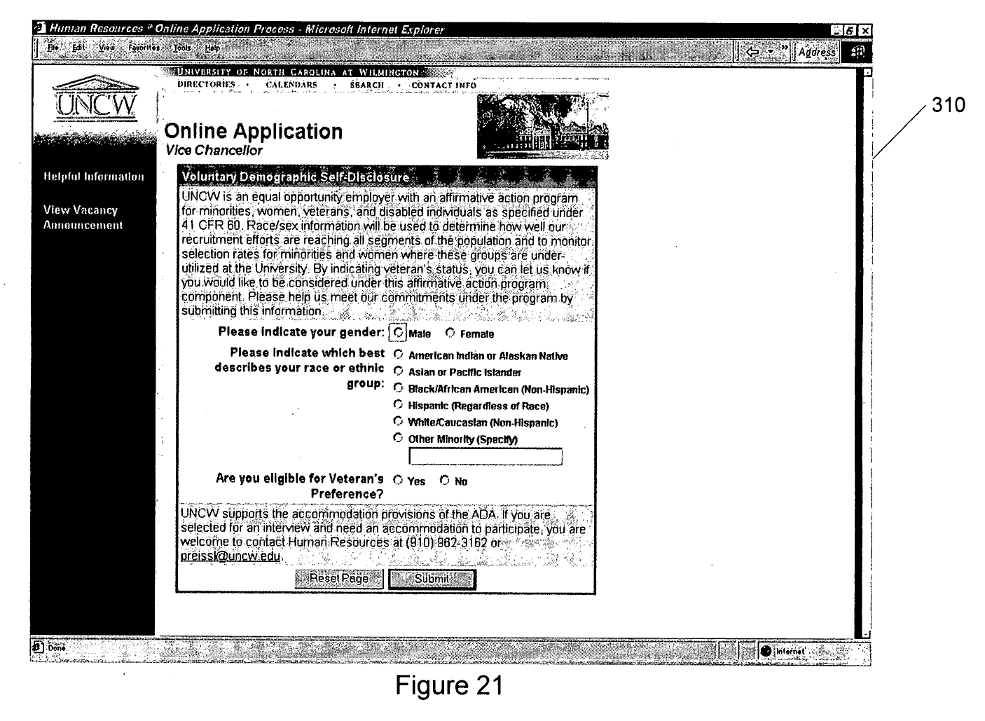

A demographic data screen 310 is illustrated in FIG. 21. On this screen, the applicant is asked to identify his/her gender, race, and eligibility for veteran's preference.

The applicant may view the Vacancy Announcement pop-up window (316) by clicking on the “View Vacancy Announcement” link in the left sidebar. The applicant may view the Helpful Information pop-up window (315) by clicking on the “Helpful Information” link in the left sidebar.

The applicant may press the 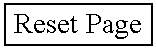
button to clear all choices and enter new information. If the applicant has previously indicated his/her choices, and then returned to the online application, the 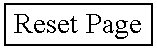
button will restore the previously entered choices.

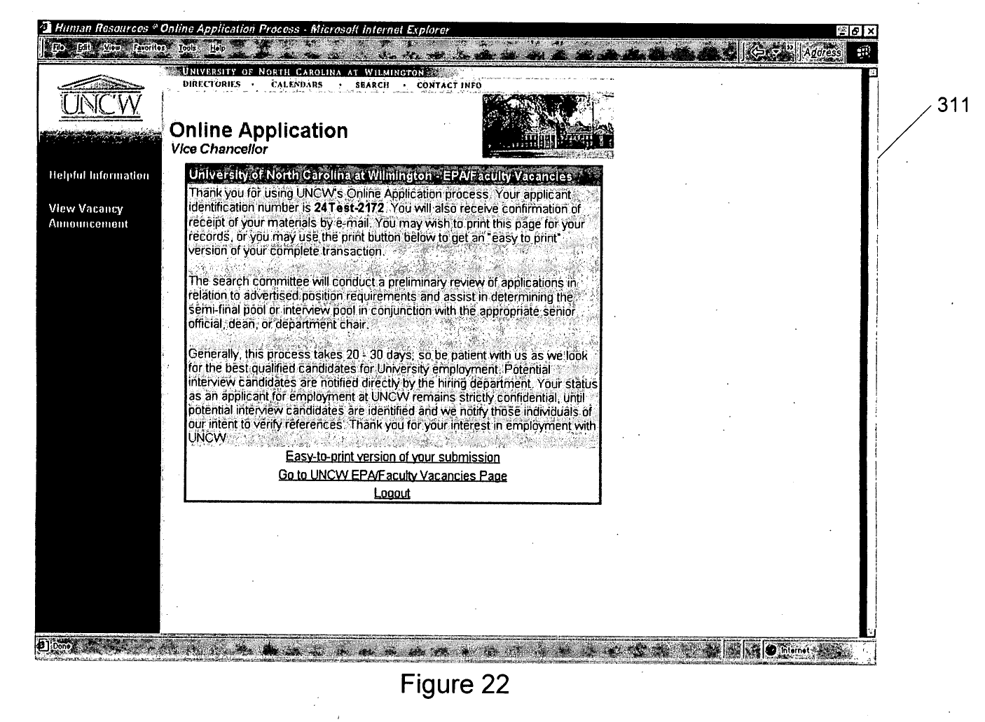

The applicant presses the 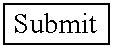
button to submit the application and move to the online application information screen (311), as illustrated in FIG. 22.

The screen of FIG. 22 displays information concerning the next steps in the process, and provides the applicant a system-generated applicant identification number.

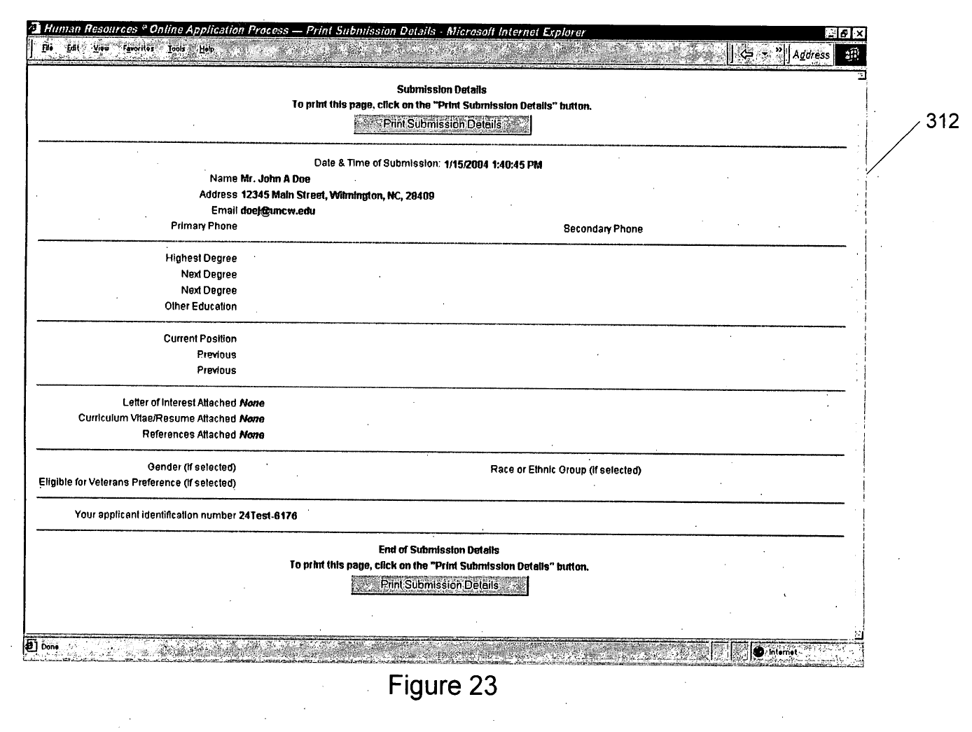

From this screen, the applicant may go to a Summary screen (312), illustrated in FIG. 23, of his application data by pressing the Easy-to-print version of your submission link.

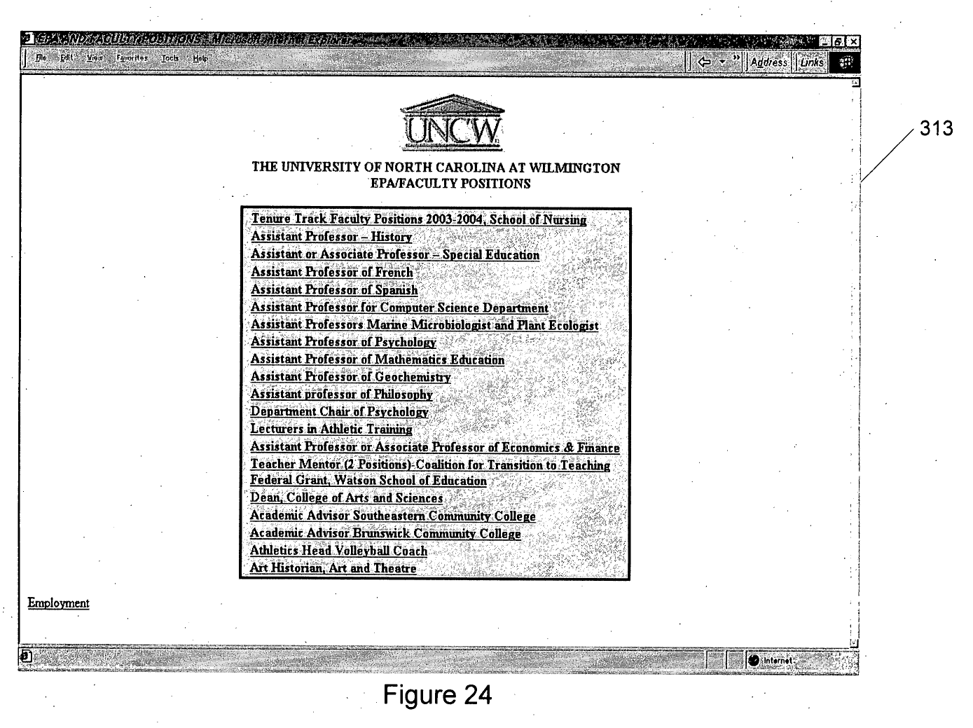

The applicant can go to the UNC Wilmington's list of vacancies (313), illustrated in FIG. 24, by pressing the Go to UNCW EPA/Faculty Vacancies Screen link.

From this screen, the applicant may go to the system's list of online vacancies (302) by pressing the Logout link.

The applicant may view the Vacancy Announcement pop-up window (316) by clicking on the “View Vacancy Announcement” link in the left sidebar. The applicant may view the Helpful Information pop-up window (315) by clicking on the “Helpful Information” link in the left sidebar.

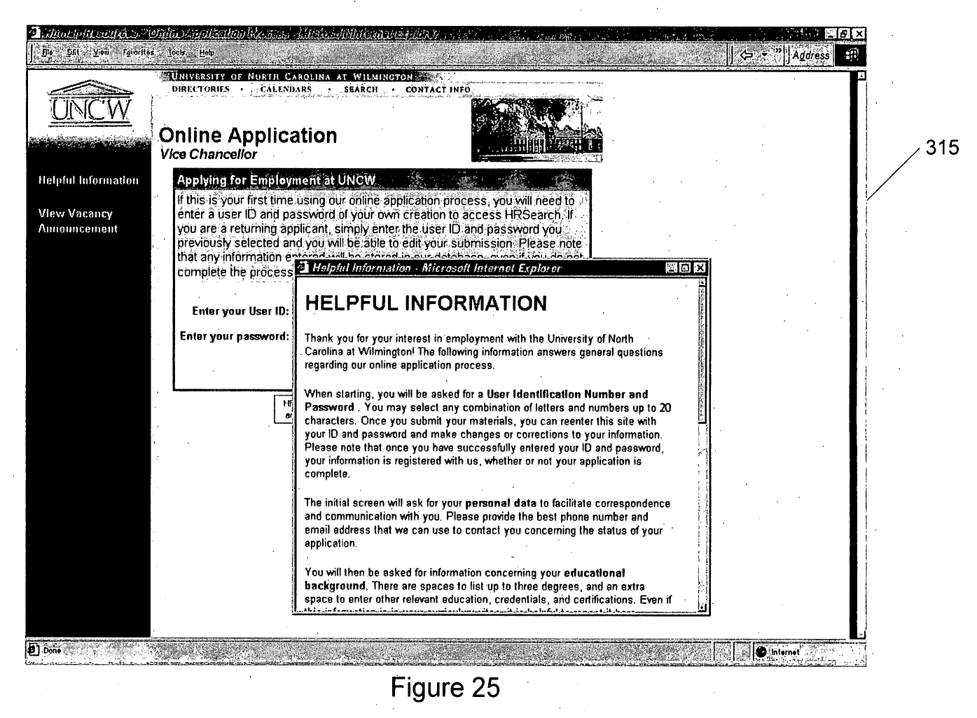

The Helpful Information pop-up window (315), illustrated in FIG. 25, is displayed by clicking on the “Helpful Information” on the sidebar continuously displayed to the applicant during the online application process. This screen provides advice to the applicant on the application process.

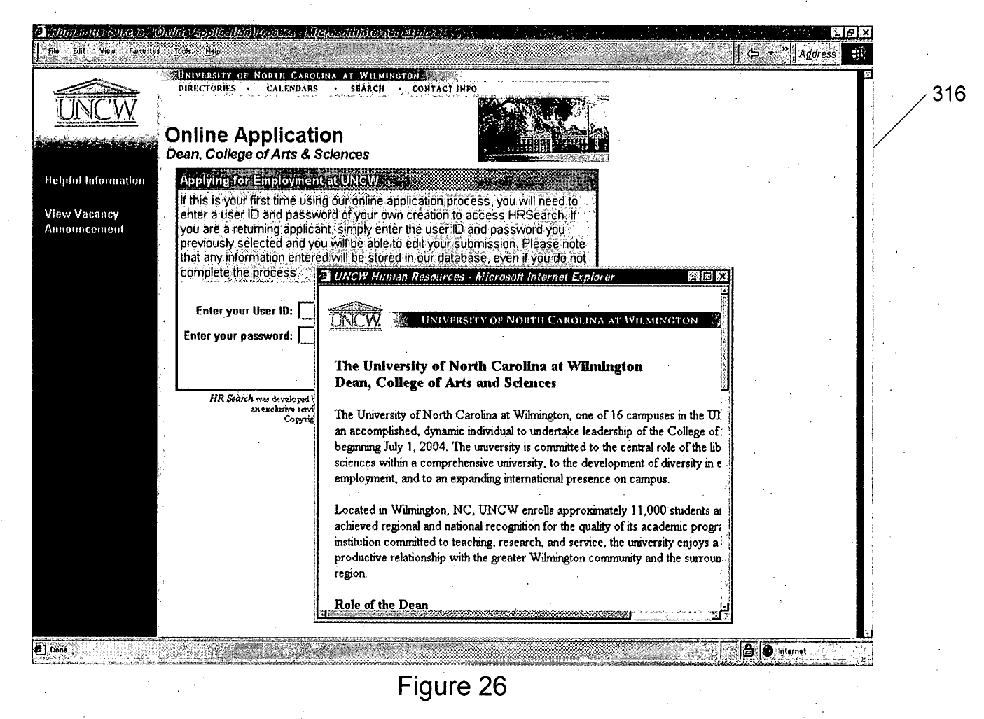

The Vacancy Announcement pop-up window (316), illustrated in FIG. 26, is displayed by clicking on “View Vacancy Announcement” on the sidebar continuously displayed to the applicant during the online application process. This screen provides a description of the vacancy to the applicant.

The system then uses the URL for the Vacancy Announcement (301) to create the Vacancy Announcement pop-up window (316).

This allows the applicant to see the vacancy announcement as he/she is completing the online job application.

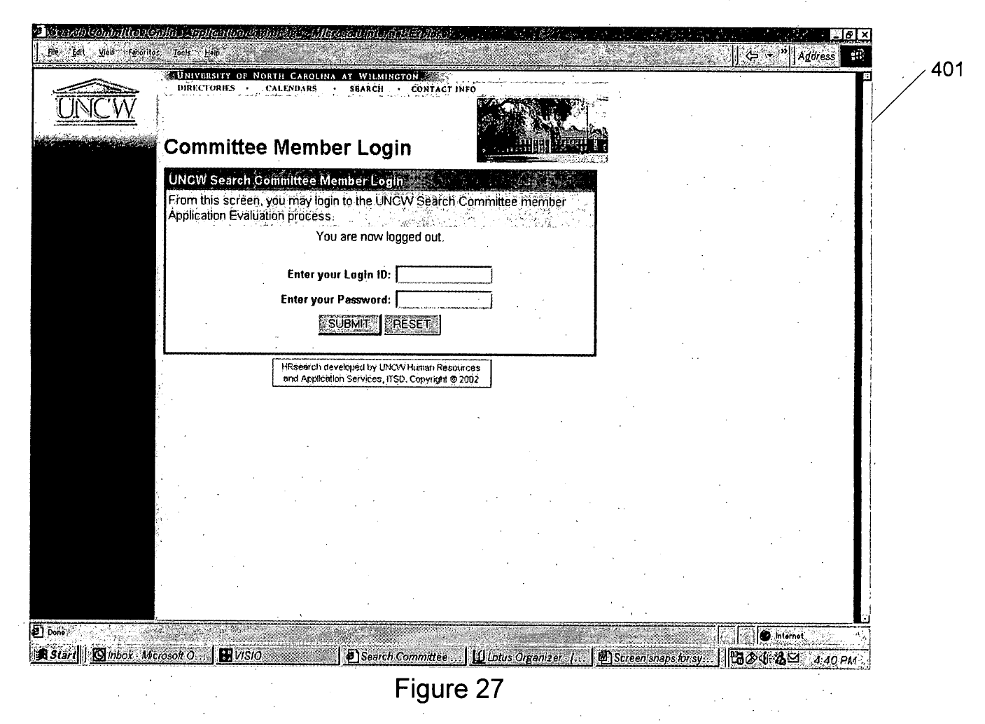

FIG. 27 illustrates a Committee Member Login screen 401. All users (System Administrator, Committee Chair, Committee Member, and Interviewer) of this system can use this page to enter their Login ID and Password.

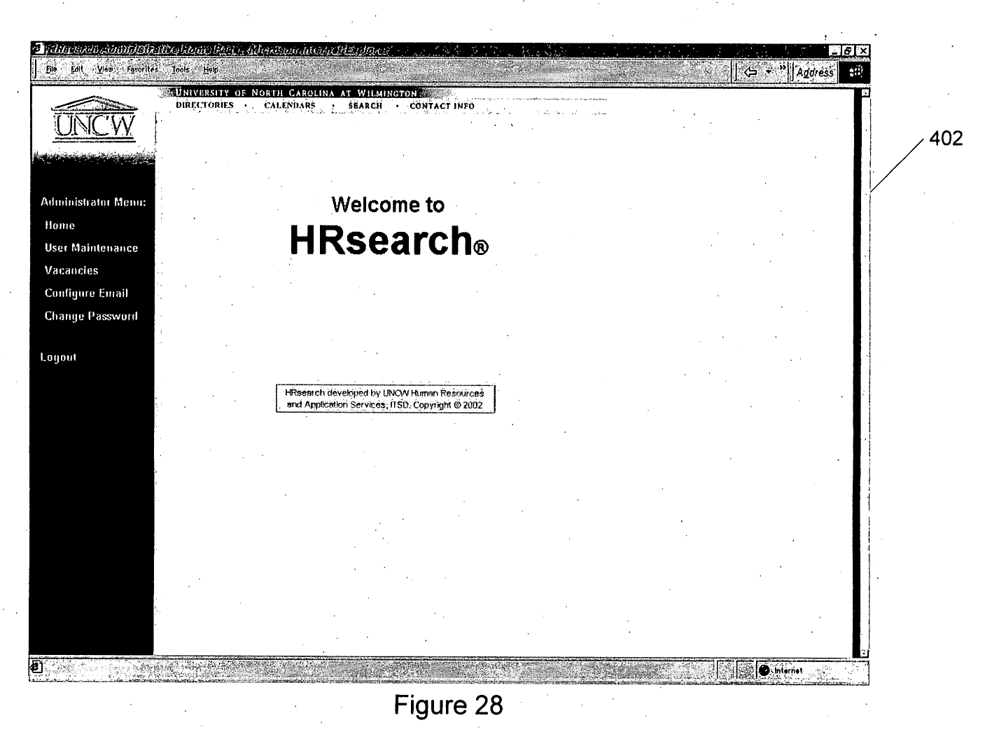

If the system recognizes that the ID and password belong to the System Administrator, the system will display the System Administrator's menu (402), illustrated in FIG. 28.

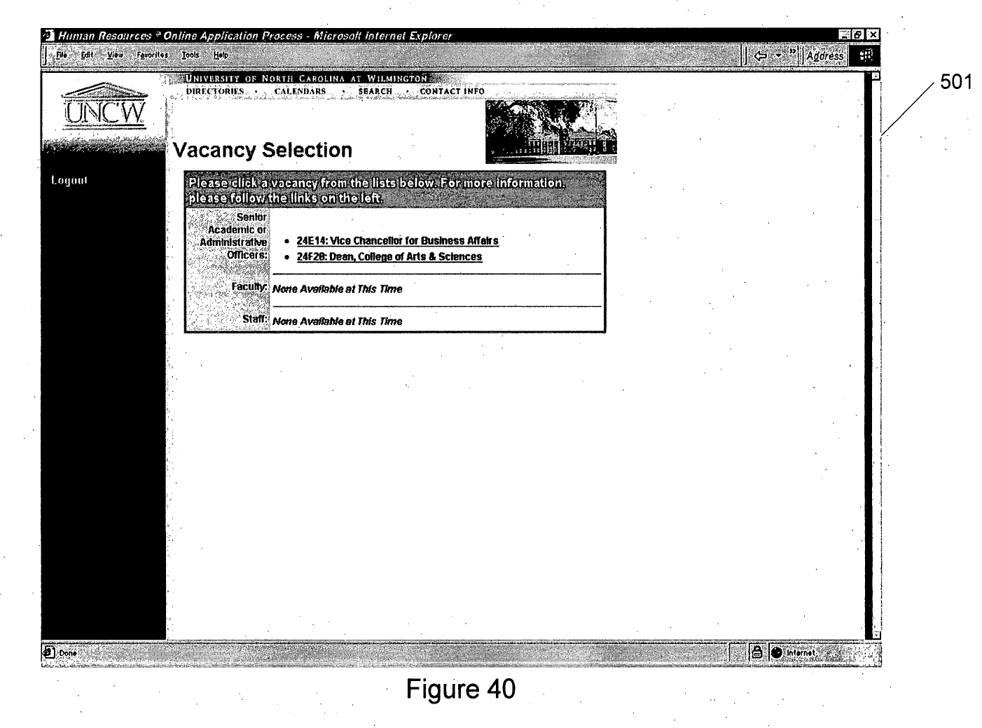

If the system recognizes that the ID and password belong to a user other than the System Administrator, the system will display the Vacancy Selection screen (501), illustrated in FIG. 40.

The System Administrator's Menu 402 of FIG. 28 is the main menu presented to the System Administrator when he/she logs into the system.

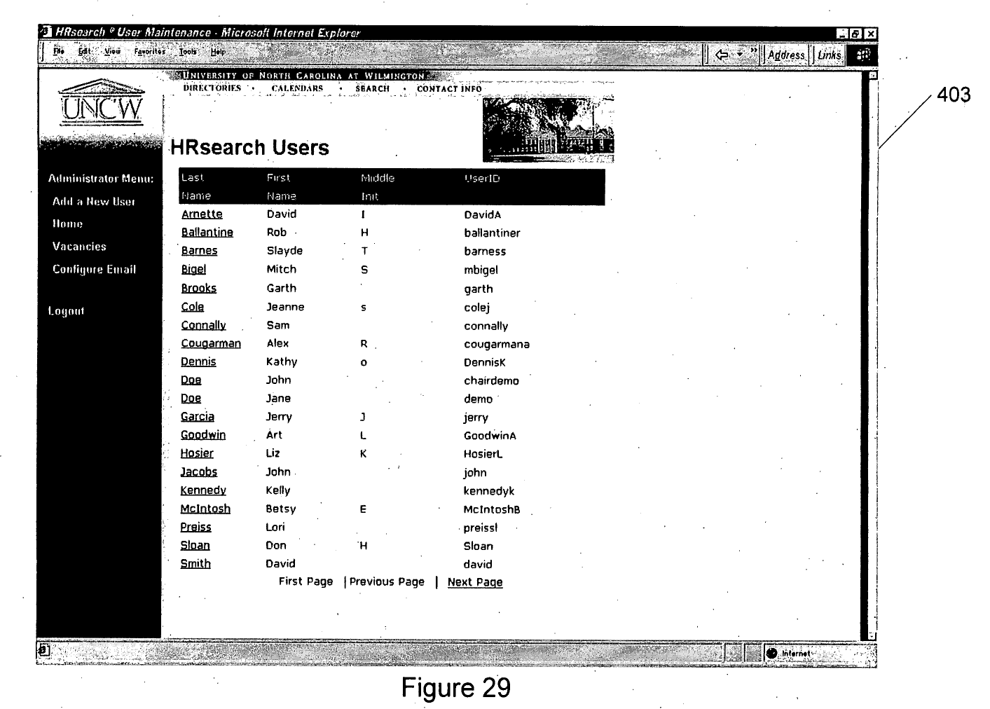

The System Administrator can set up new users and maintain user accounts by clicking on “User Maintenance” on the left sidebar. The system will then display the HRsearch Users page (403), illustrated in FIG. 29.

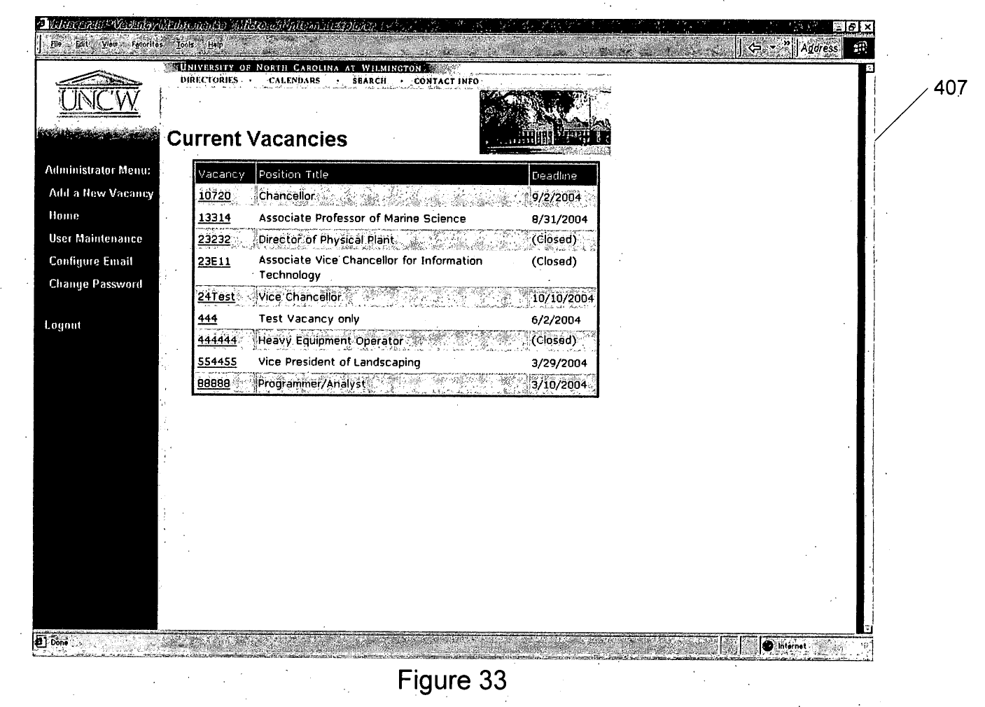

The System Administrator can manage the vacancies on the system by clicking on “Vacancies” on the left sidebar. The system will then display the Current Vacancies screen (407), illustrated in FIG. 33.

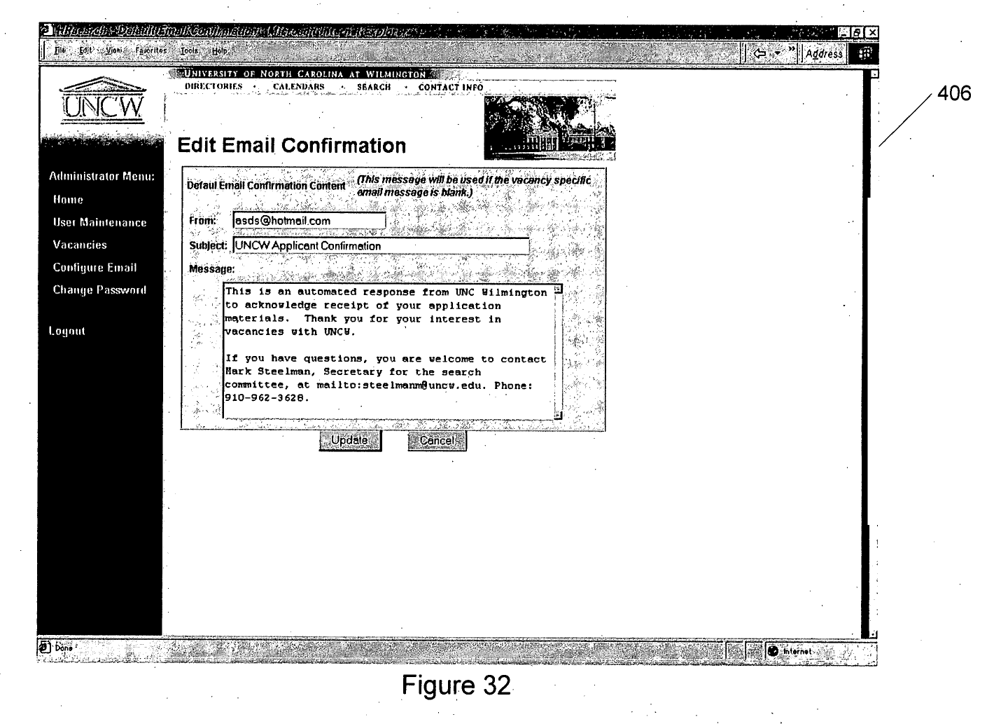

The System Administrator can edit the default email sent to applicants by clicking on “Configure Email” on the left sidebar. The system will then display the Edit Email Confirmation page (406), illustrated in FIG. 32.

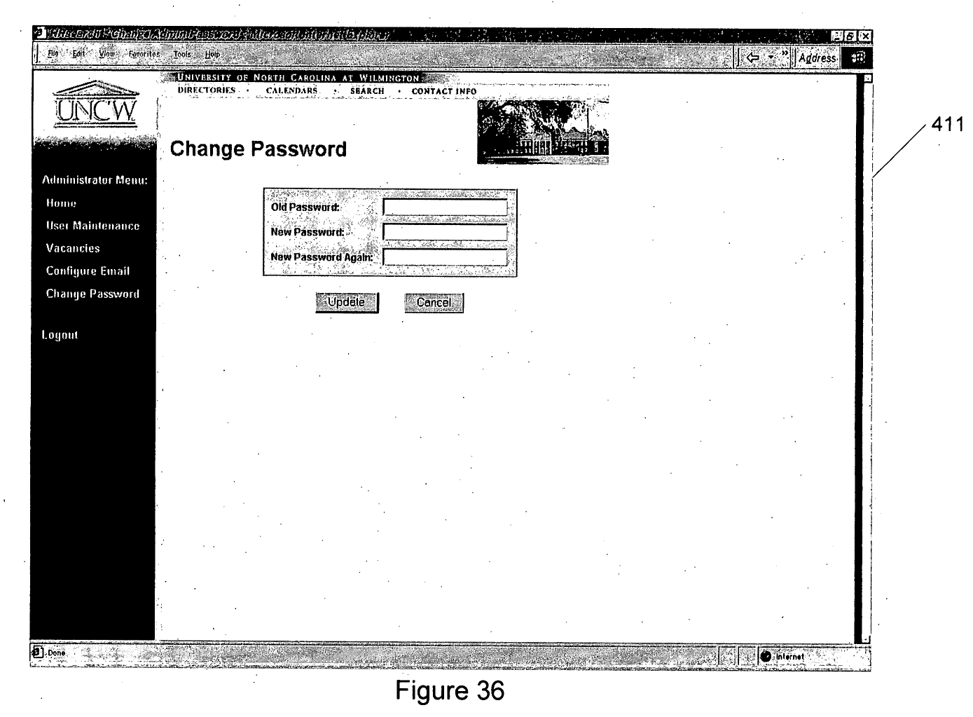

The System Administrator can change the System Administrator's password by clicking on “Change Password” in the left sidebar. The system will then display the Change Password page (411), illustrated in FIG. 36.

The System Administrator can logout of the system by clicking on “Logout” in the left sidebar. The system will then display Committee Member Login screen (401), illustrated in FIG. 27.

The HRsearch Users screen 403, illustrated in FIG. 29, is displayed if the System Administrator selects “User Maintenance” from the System Administrator's menu (402) in FIG. 28. This page displays a list of users who have system accounts (which have been previously entered by the System Administrator). Additional users are displayed by selecting Next Page on the screen.

The System Administrator can edit the user's account by first clicking on the Last Name of the user from the list.

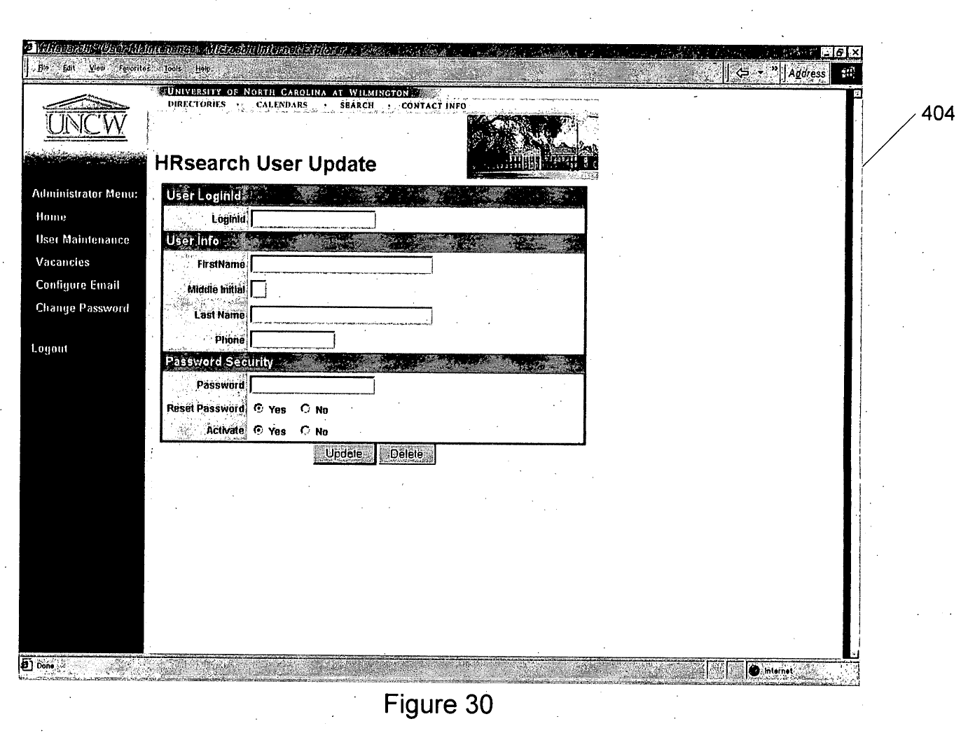

The System Administrator can add a new user by clicking on “Add a new User” on the left sidebar. The system will then display the HRsearch User Update screen (404), illustrated in FIG. 30.

The System Administrator can return to the System Administrator's menu by clicking on “Home” on the left sidebar. The system will then display the Welcome to HRsearch screen (System Administrator's menu) (402) of FIG. 28.

The System Administrator can manage the vacancies on the system by clicking on “Vacancies” on the left sidebar. The system will then display the Current Vacancies screen (407), illustrated in FIG. 33.

The System Administrator can edit the default email sent to applicants by clicking on “Configure Email” on the left sidebar. The system will then display the Edit Email Confirmation page (406), illustrated in FIG. 32.

The System Administrator can logout of the system by clicking on “Logout” in the left sidebar. The system will then display Committee Member Login screen (401) (FIG. 27).

The HRsearch User Update screen 404 (FIG. 30) allows the System Administrator to add information on a new user. The System Administrator enters a Loginld, the First Name, Middle Initial, Last Name and Phone number of the user.

The System Administrator also enters a password that the user will need to use to gain access to the system. If the System Administrator wants to enable the user to change the password when the user first logins in (401) (FIG. 27), the System Administrator can select YES for the Reset Password option.

The System Administrator can anticipate that certain individuals will need access to the system, and add their accounts before they are actually needed by the user. If this is the case, the System Administrator can enter all the fields and set the “Activate” option to “No”. If the option is set to “No”, then the user will not be able to login to the system (401) (FIG. 27) until the System Administrator sets the option to “Yes”.

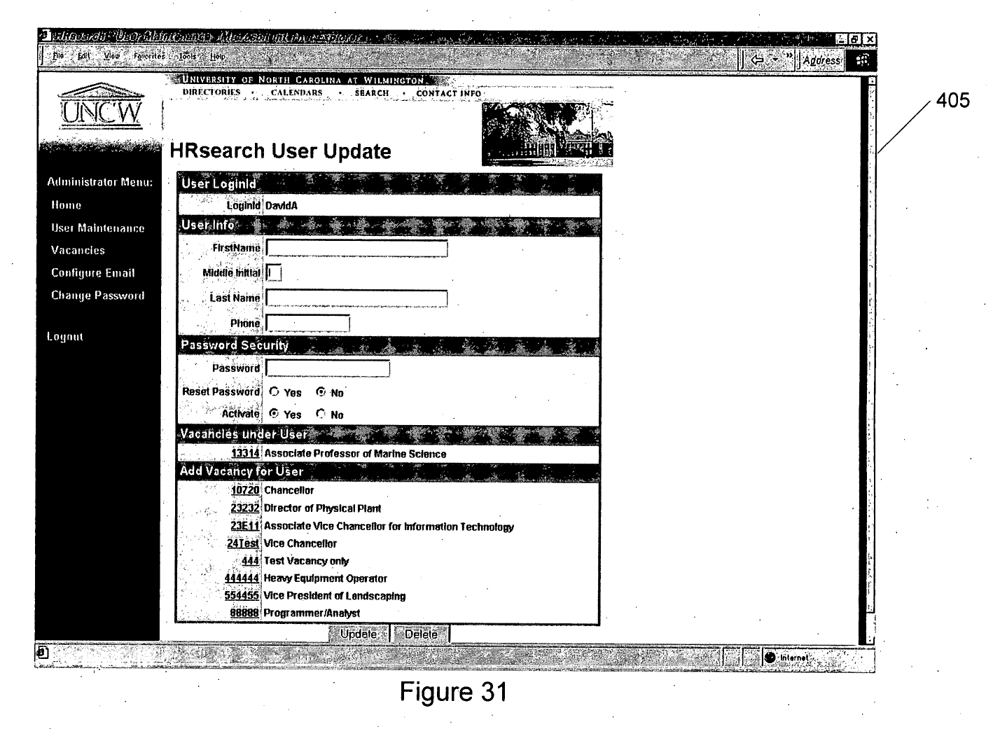

The System Administrator presses the 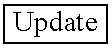
button to save the entered information and return to the User Update screen (405), illustrated in FIG. 31. The System Administrator presses the 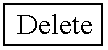
button to clear the entered information from the fields and return to the HRsearch Users screen (403) (FIG. 29).

The System Administrator can return to the System Administrator's menu by clicking on “Home” on the left sidebar. The system will then display the Welcome to HRsearch screen (System Administrator's menu) (402) (FIG. 28).

The System Administrator can set up new users and maintain user accounts by clicking on “User Maintenance” on the left sidebar. The system will then display the HRsearch Users page (403) (FIG. 29).

The System Administrator can manage the vacancies on the system by clicking on “Vacancies” on the left sidebar. The system will then display the Current Vacancies screen (407) (FIG. 33).

The System Administrator can edit the default email sent to applicants by clicking on “Configure Email” on the left sidebar. The system will then display the Edit Email Confirmation page (406) (FIG. 32).

The System Administrator can change the System Administrator's password by clicking on “Change Password” in the left sidebar. The system will then display the Change Password page (411) (FIG. 36).

The System Administrator can logout of the system by clicking on “Logout” in the left sidebar. The system will then display Committee Member Login screen (401) (FIG. 27).

The HRsearch User Update screen 405 (FIG. 31) is displayed if the System Administrator clicks on the user's last name on the HRsearch Users screen (403) (FIG. 29).

The System Administrator can edit the user's First Name, Middle Initial, Last Name, and Phone Number. The System Administrator can change the user's password. If the System Administrator wants to enable the user to change the password when the user first logins in (401) (FIG. 27), the System Administrator can select “Yes” for the “Reset Password” option.

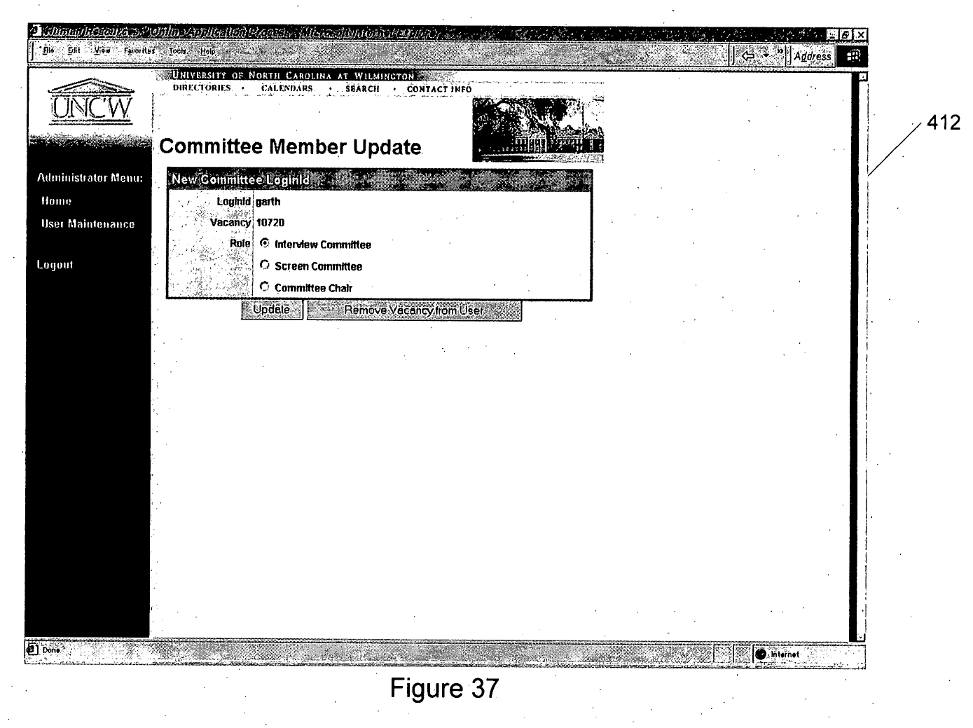

The System Administrator can change the user's access level for any vacancy to which the user already has access. Clicking on the vacancy number under the section “Vacancies under User” will take the System Administrator to the Committee Member Update screen (412) (FIG. 37) to edit the user's access level.

The System Administrator can add a vacancy to the user's account. Clicking on the vacancy number under the section “Add Vacancy for User” will take the System Administrator to the Committee Member Update screen (412) (FIG. 37) so that the System Administrator can select the level of access for the user for that vacancy. When that is done, the HRsearch User Update screen (405) (FIG. 31) will display the vacancy number and title under the section “Vacancies Under User”.

The System Administrator can remove a vacancy from the user's account. Clicking on the vacancy number under the section “Vacancies under User” will take the System Administrator to the Committee Member Update screen (412) (FIG. 37) so that the System Administrator can remove the vacancy from the user.

The System Administrator can disable the user's access to the system without deleting the user's account and his/her previously entered rating scores. To disable access to the system, the System Administrator sets the “Activate” option to “No”. If the option is set to “No”, then the user will not be able to login to the system (401) (FIG. 27) until the System Administrator sets the option to “Yes”.

The System Administrator presses 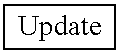
to save changes and return to the HRsearch User Update screen (405) (FIG. 31).

The System Administrator presses 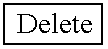
to remove the user from the system and return to the HRsearch Users screen (403) (FIG. 29).

The Edit Email Confirmation screen 406, illustrated in FIG. 32, allows the System Administrator to adjust the content of the default email confirmation that is sent to applicants following successful submission of their online applications.

The System Administrator can enter or modify the “From” address that will appear to applicants, the Subject line of the email message, and the contents of the message.

The System Administrator can save the changes by pressing the 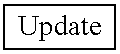
button and return to the System Administrator's menu (402) (FIG. 28).

The System Administrator can ignore the changes by pressing the 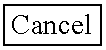
button and returning to the previously displayed page.

The System Administrator can return to the System Administrator's menu by clicking on “Home” on the left sidebar. The system will then display the Welcome to HRsearch screen (System Administrator's menu) (402) (FIG. 28).

The System Administrator can set up new users and maintain user accounts by clicking on “User Maintenance” on the left sidebar. The system will then display the HRsearch Users page (403) (FIG. 29).

The System Administrator can manage the vacancies on the system by clicking on “Vacancies” on the left sidebar. The system will then display the Current Vacancies screen (407) (FIG. 33).

The System Administrator can edit the default email sent to applicants by clicking on “Configure Email” on the left sidebar. The system will then display the Edit Email Confirmation page (406) (FIG. 32).

The System Administrator can change the System Administrator's password by clicking on “Change Password” in the left sidebar. The system will then display the Change Password page (411) (FIG. 36).

The System Administrator can logout of the system by clicking on “Logout” in the left sidebar. The system will then display Committee Member Login screen (401) (FIG. 27).

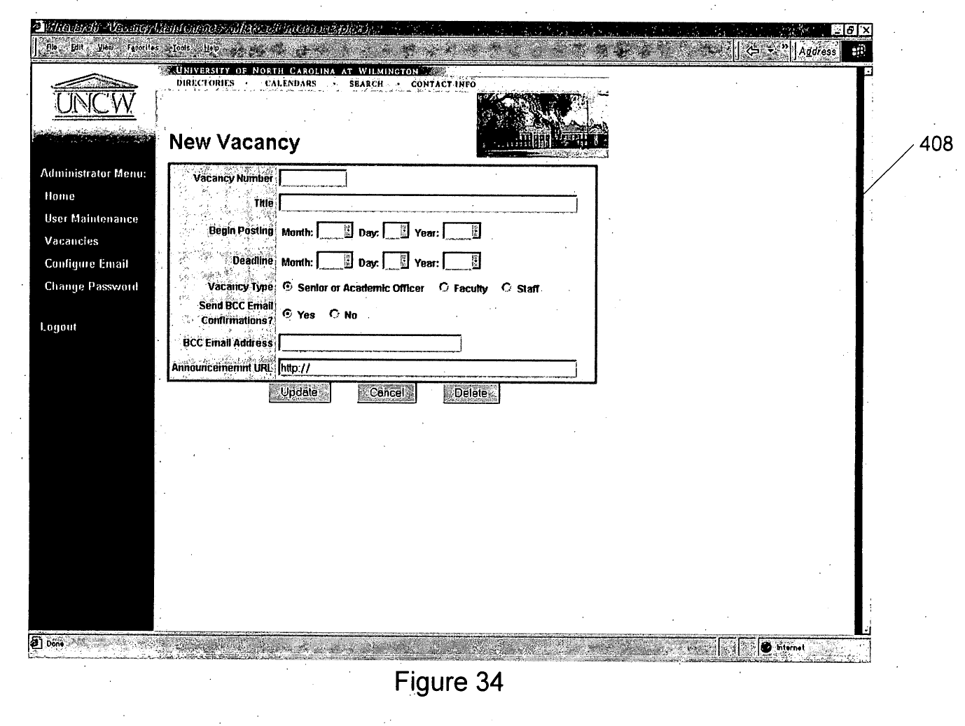

The Current Vacancies Screen 407, illustrated in FIG. 33, displays all of the vacancies in the HRsearch system. Clicking on the vacancy number will display the Edit Vacancy Information screen (408) (FIG. 34).

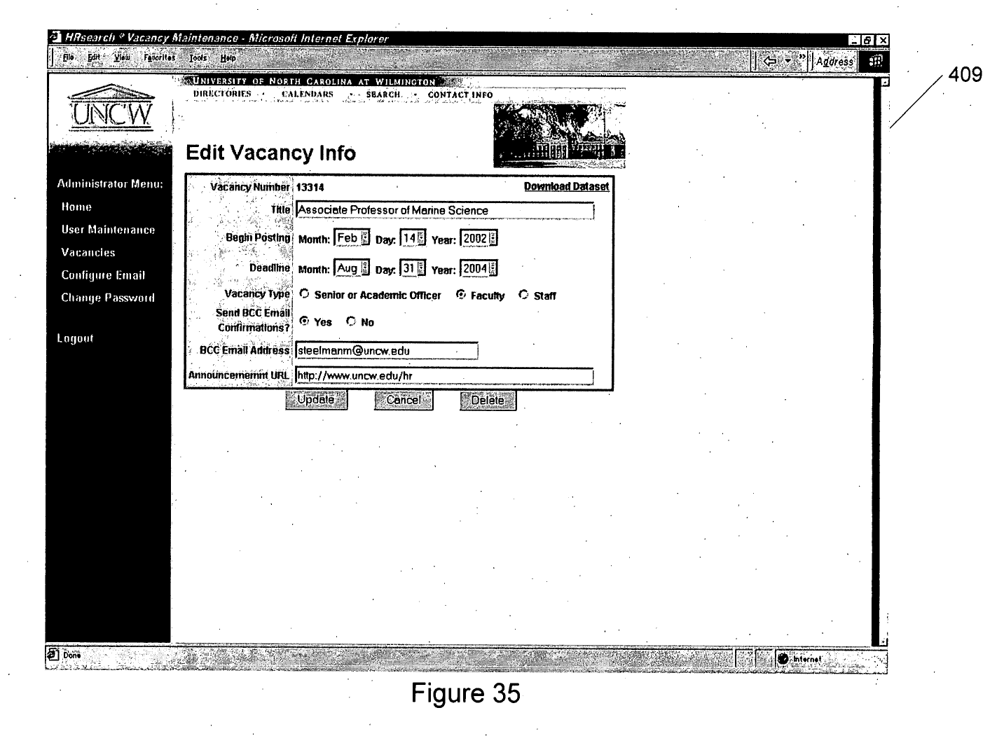

The System Administrator can add a new vacancy to the system by clicking on “Add a New Vacancy” on the left sidebar. The system will then display the New Vacancy screen (409) (FIG. 35).

The System Administrator can return to the System Administrator's menu by clicking on “Home” on the left sidebar. The system will then display the Welcome to HRsearch screen (System Administrator's menu) (402) (FIG. 28).

The System Administrator can set up new users and maintain user accounts by clicking on “User Maintenance” on the left sidebar. The system will then display the HRsearch Users screen (403) (FIG. 29).

The System Administrator can edit the default email sent to applicants by clicking on “Configure Email” on the left sidebar. The system will then display the Edit Email Confirmation screen (406) (FIG. 32).

The System Administrator can change the System Administrator's password by clicking on “Change Password” in the left sidebar. The system will then display the Change Password screen (411) (FIG. 36).

The System Administrator can logout of the system by clicking on “Logout” in the left sidebar. The system will then display Committee Member Login screen (401) (FIG. 27).

The System Administrator uses the New Vacancy screen 408, illustrated in FIG. 34, to add a vacancy to the system. The system administrator can enter the vacancy title that will be displayed on the Current Vacancies screen (407) (FIG. 33).

The System Administrator can control when the vacancy will first appear on the Vacancy Selection page (302) for the applicants. The System Administrator can enter a deadline date, which will show applicants that the vacancy is “closed” on the Vacancy Selection page (302) (FIG. 10).

The System Administrator can select the category (Senior or Academic Officer, Faculty or Staff) in which the vacancy title will be shown on the Vacancy Selection page (302) (FIG. 10).

The System Administrator can enter the email address of a person to receive blind carbon copies of the email confirmation message (314) sent to applicants.

The System Administrator can enter and edit the URL of the vacancy announcement (301) (FIG. 9).

The System Administrator can return to the System Administrator's menu by clicking on “Home” on the left sidebar. The system will then display the Welcome to HRsearch screen (System Administrator's menu) (402) (FIG. 28).

The System Administrator can set up new users and maintain user accounts by clicking on “User Maintenance” on the left sidebar. The system will then display the HRsearch Users page (403) (FIG. 29).

The System Administrator can manage the vacancies on the system by clicking on “Vacancies” on the left sidebar. The system will then display the Current Vacancies screen (407) (FIG. 33).

The System Administrator can edit the default email sent to applicants by clicking on “Configure Email” on the left sidebar. The system will then display the Edit Email Confirmation page (406) (FIG. 32).

The System Administrator can change the System Administrator's password by clicking on “Change Password” in the left sidebar. The system will then display the Change Password page (411) (FIG. 36).

The System Administrator can logout of the system by clicking on “Logout” in the left sidebar. The system will then display Committee Member Login screen (401) (FIG. 27).

The System Administrator uses the Edit Vacancy Information screen 409, illustrated in FIG. 35, to enter and edit information about a vacancy currently in the system. The system administrator can enter the vacancy title that will be displayed on the Current Vacancies screen (407) (FIG. 33).

The System Administrator can control when the vacancy will first appear on the Vacancy Selection page (302) (FIG. 10) for the applicants. The System Administrator can enter a deadline date, which will show applicants that the vacancy is “closed” on the Vacancy Selection page (302) (FIG. 10).

The System Administrator can select the category (Senior or Academic Officer, Faculty or Staff) in which the vacancy title will be shown on the Vacancy Selection page (302) (FIG. 10).

The System Administrator can enter the email address of a person to receive blind carbon copies of the email confirmation message (314) sent to applicants.

The System Administrator can enter and edit the URL of the vacancy announcement (301) (FIG. 9).

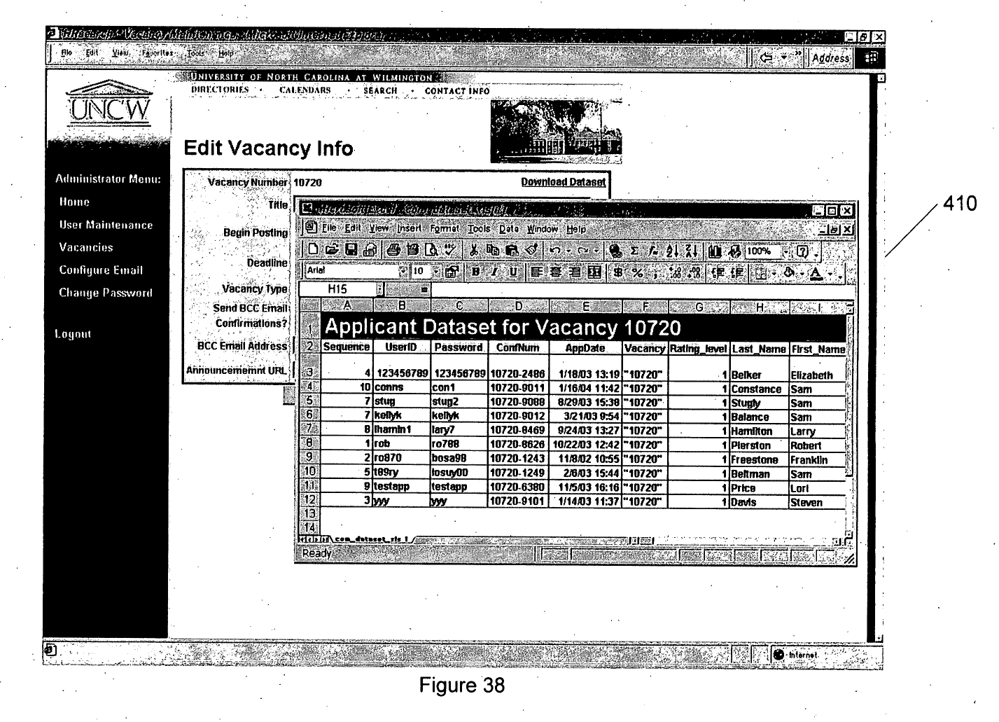

The System Administrator can download the dataset of applicant data for the vacancy by clicking on Download Dataset. This launches a spreadsheet such as Excel on the System Administrator's computer and displays the dataset as an Excel spreadsheet (410) (FIG. 38).

The System Administrator presses 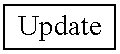
to save changes and return to the Current Vacancies screen (407) (FIG. 33).

The System Administrator presses 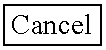
to ignore the changes and return to the Current Vacancies screen (407) (FIG. 33).

The System Administrator presses 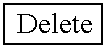
to remove the vacancy from all lists and return to the Current Vacancies screen (407) (FIG. 33).

The System Administrator can return to the System Administrator's menu by clicking on “Home” on the left sidebar. The system will then display the Welcome to HRsearch screen (System Administrator's menu) (402) (FIG. 28).

The System Administrator can set up new users and maintain user accounts by clicking on “User Maintenance” on the left sidebar. The system will then display the HRsearch Users page (403) (FIG. 29).

The System Administrator can manage the vacancies on the system by clicking on “Vacancies” on the left sidebar. The system will then display the Current Vacancies screen (407) (FIG. 33).

The System Administrator can edit the default email sent to applicants by clicking on “Configure Email” on the left sidebar. The system will then display the Edit Email Confirmation page (406) (FIG. 32).

The System Administrator can change the System Administrator's password by clicking on “Change Password” in the left sidebar. The system will then display the Change Password page (411) (FIG. 36).

The System Administrator can logout of the system by clicking on “Logout” in the left sidebar. The system will then display Committee Member Login screen (401) (FIG. 27).

The System Administrator uses the Change Password screen (411), illustrated in FIG. 36, to change the system Administrator's password. The System Administrator must enter the old password, and the new password twice, and press the 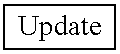
button. The System Administrator can ignore the changes and return to the System Administrator's menu (402) (FIG. 28) by pressing the 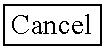
button.

The System Administrator can return to the System Administrator's menu by clicking on “Home” on the left sidebar. The system will then display the Welcome to HRsearch screen (System Administrator's menu) (402) (FIG. 28).

The System Administrator can set up new users and maintain user accounts by clicking on “User Maintenance” on the left sidebar. The system will then display the HRsearch Users screen (403) (FIG. 29).

The System Administrator can manage the vacancies on the system by clicking on “Vacancies” on the left sidebar. The system will then display the Current Vacancies screen (407) (FIG. 33).

The System Administrator can edit the default email sent to applicants by clicking on “Configure Email” on the left sidebar. The system will then display the Edit Email Confirmation page (406) (FIG. 32).

The System Administrator can change the System Administrator's password by clicking on “Change Password” in the left sidebar. The system will then display the Change Password page (411) (FIG. 36).

The System Administrator can logout of the system by clicking on “Logout” in the left sidebar. The system will then display Committee Member Login screen (401) (FIG. 27).

The Committee Memory Update screen 412, illustrated in FIG. 37, appears if the System Administrator has clicked on the vacancy number under either the “Vacancies under User” section or “Add Vacancy for User” section on the HRsearch User Update screen (405) (FIG. 31).

This screen allows the System Administrator to select the level of access the user will have for a specific vacancy (Interviewer, Committee Member, or Committee Chair). Once that selection is made, the System Administrator presses the 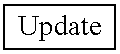
button, which registers the change and causes the system to display the HRsearch User Update screen (405) (FIG. 31).

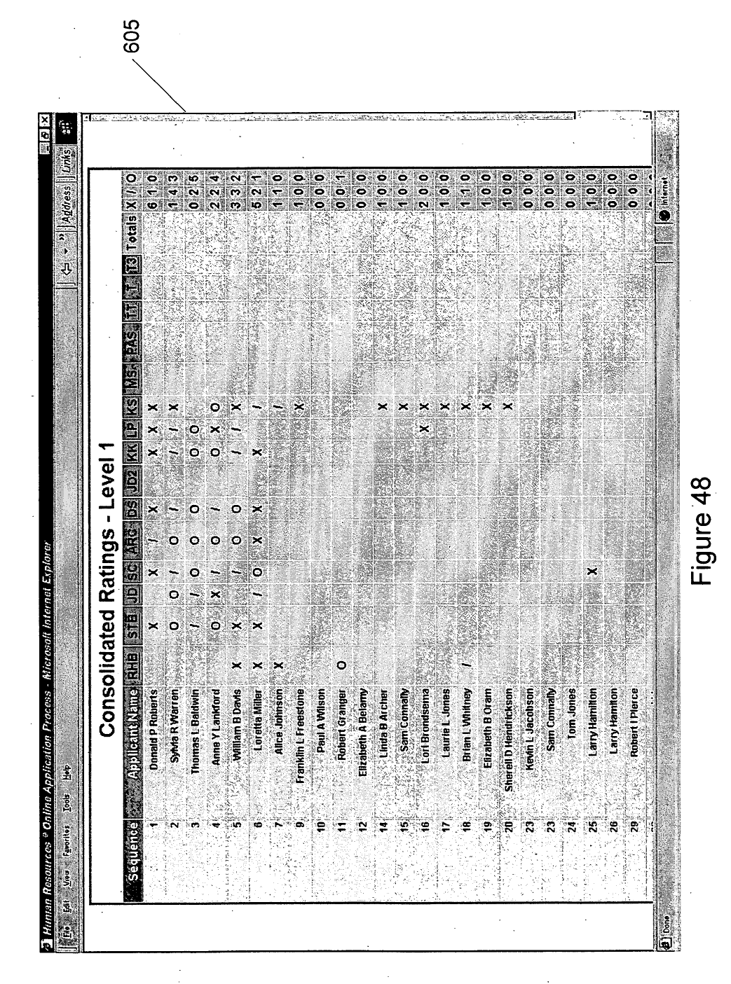

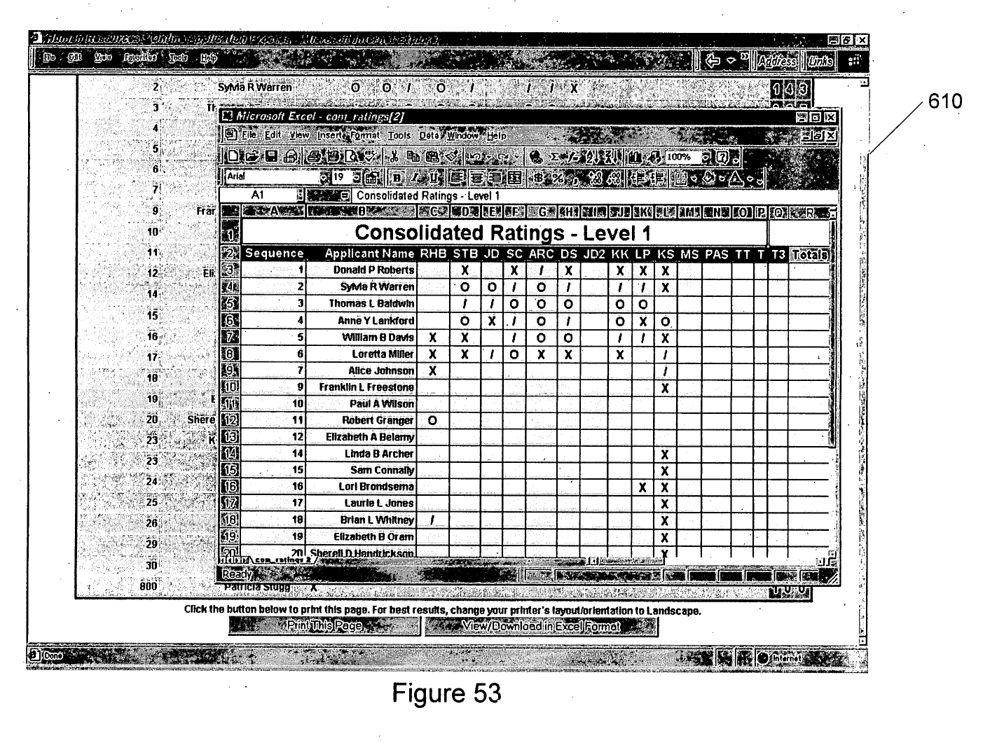

If the system Administrator wants to remove the vacancy from the user, the System Administrator presses the 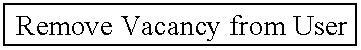
button. This will remove the vacancy from the user's choices on the Vacancy Selection screen (501) (FIG. 40) and thus prevent the user from being able to gain access to the vacancy. This will also cause the user's evaluation scores to be removed from the Consolidated Ratings screen (605) (FIG. 48) and printouts (610) (FIG. 53) and will cause the system to display the HRsearch User Update screen (405) (FIG. 31). If the System Administrator later adds back the vacancy to the user, the user's previously entered ratings scores will appear on the Consolidated Ratings screen (605) (FIG. 48) and printouts (610) (FIG. 53).

The System Administrator can return to the System Administrator's menu by clicking on “Home” on the left sidebar. The system will then display the Welcome to HRsearch screen (System Administrator's menu) (402) (FIG. 28).

The System Administrator can set up new users and maintain user accounts by clicking on “User Maintenance” on the left sidebar. The system will then display the HRsearch Users page (403) (FIG. 29).

The System Administrator can logout of the system by clicking on “Logout” in the left sidebar. The system will then display Committee Member Login screen (401) (FIG. 27).

Clicking on “Download Dataset” on the Edit Vacancy Info screen 409 (FIG. 35) launches a spreadsheet, such as MS Excel, and delivers data on all applicants for a specific vacancy in an Excel file 410 (FIG. 38).

The System Administrator can use the Excel features to sort the applicant data and print out information concerning the applicants.

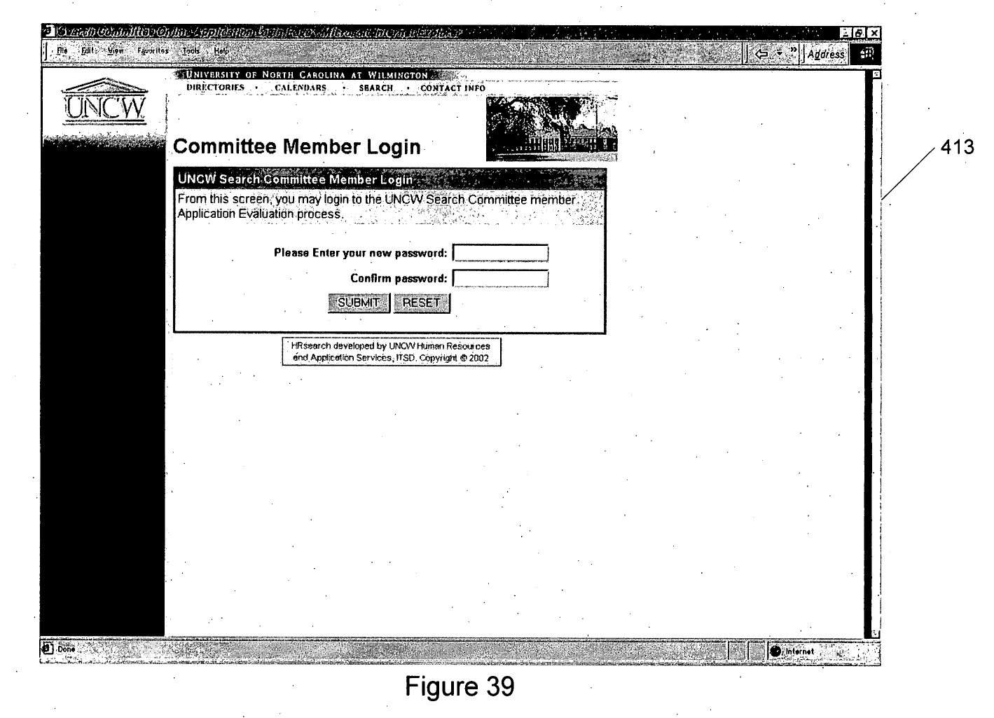

The Committee Member Login-Initial Password Change screen 413 is illustrated in FIG. 39 and is displayed if the System Administrator wants to enable the user to change the password when the user first logs in (401) (FIG. 27), the System Administrator can select “Yes” for the Reset Password option on the HRsearch User Update screen (404) (FIG. 30).

Pressing the 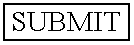
button accepts the new password entered by the user and displays the Vacancy Selection screen (501) (FIG. 40).

Pressing the 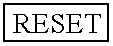
button clears the boxes so the user can enter new passwords.

The Vacancy Selection screen (501) (FIG. 40) is displayed to users (Committee Chair, Committee member, and Interviewer) after successfully logging in. The system displays only those vacancies for which the user has been granted access by the System Administrator (412) (FIG. 37).

At this screen, the user clicks on the vacancy for which he/she wants to view the applicants.

The user can also click on the “Logout” option on the left sidebar and return to the Committee Member Login screen (401) (FIG. 27).

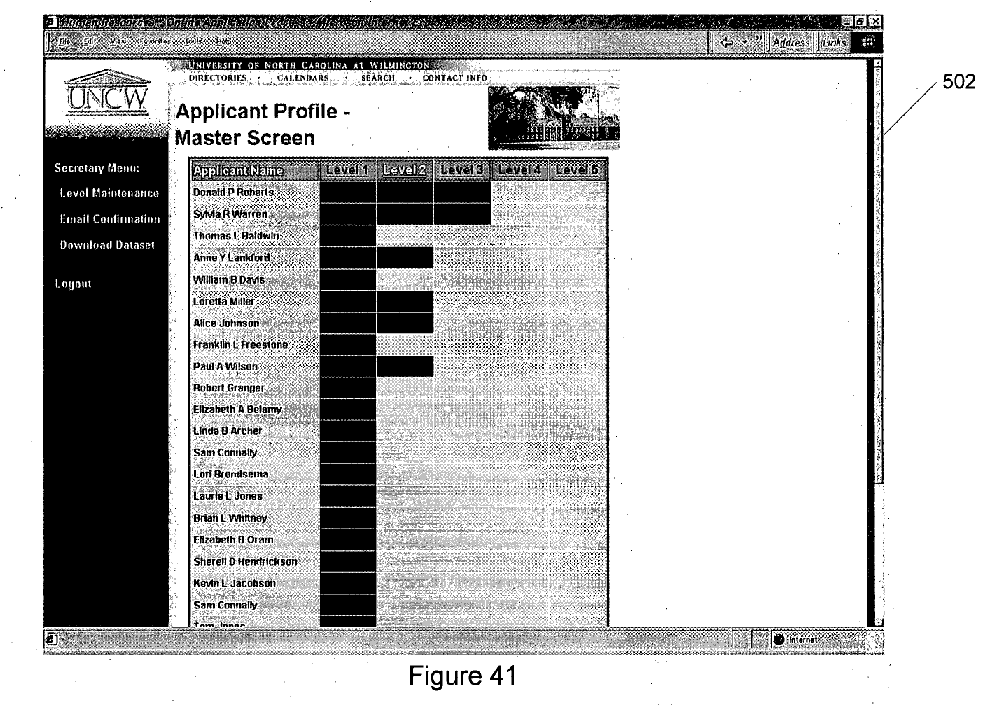

The Applicant Profile-Master Screen for Search Committee Chair screen 502 is illustrated in FIG. 41 and is displayed to users who serve as a Committee Chair for the selected vacancy. The screen displays the names of all applicants in the order in which their electronic applications were received. The five columns to the right of the names display the level to which each applicant has attained in the selection process by showing a bar moving through the columns.

On this screen, the Committee Chair selects the level for which he/she desires to review the applications, and clicks on the column header.

The Committee Chair user can also click on the “Logout” option on the left sidebar and return to the Committee Member Login screen (401) (FIG. 27).

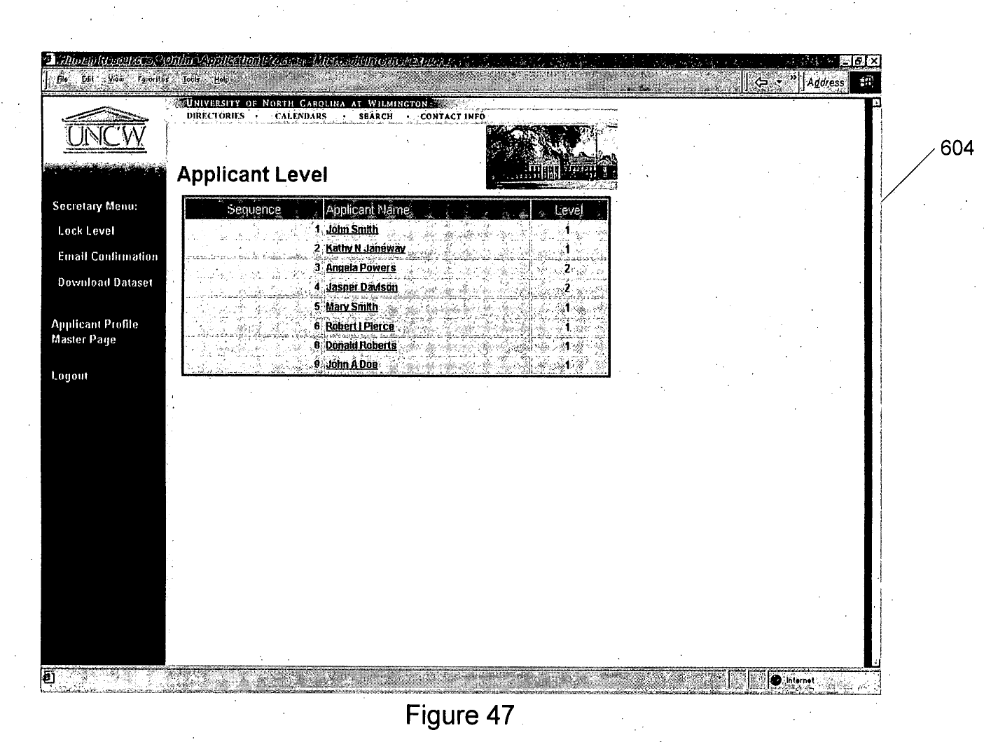

The Committee Chair can click on “Level Maintenance” in the left sidebar to move applicants to different levels in the system (604) (FIG. 47).

The Committee Chair can click on “Email Confirmation” in the left sidebar to edit the content of the automated email sent to applicants (314).

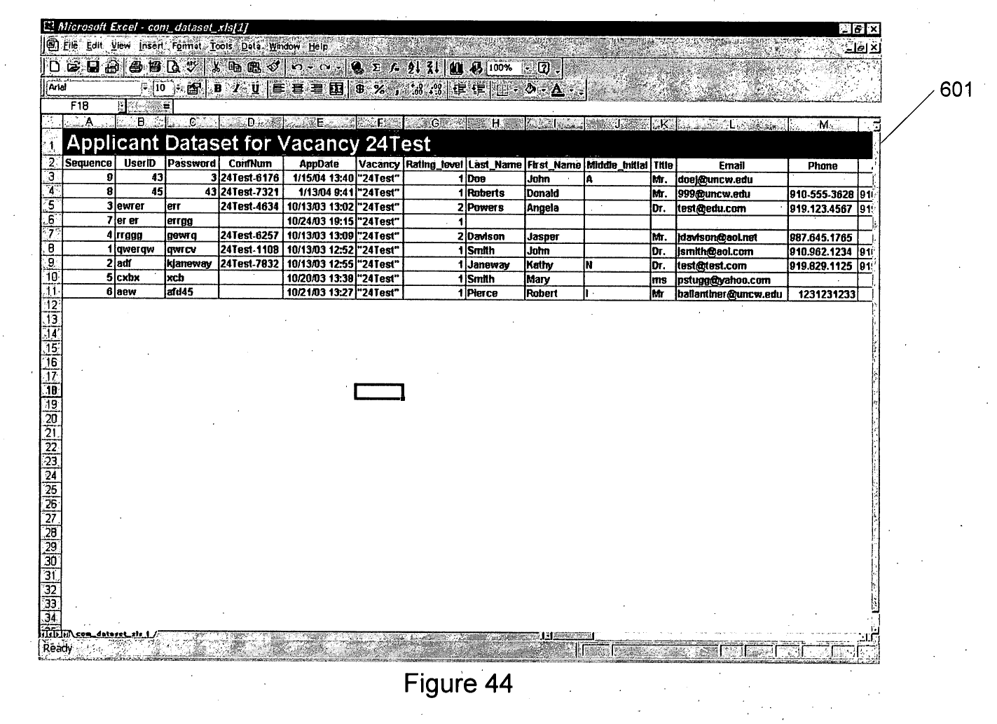

The Committee Chair can click on “Download Dataset” in the left sidebar to download an excel file of applicant information (601) (FIG. 44).

The Committee Chair can click on “Logout” in the left sidebar and return to the Committee Member Login screen (401) (FIG. 27).

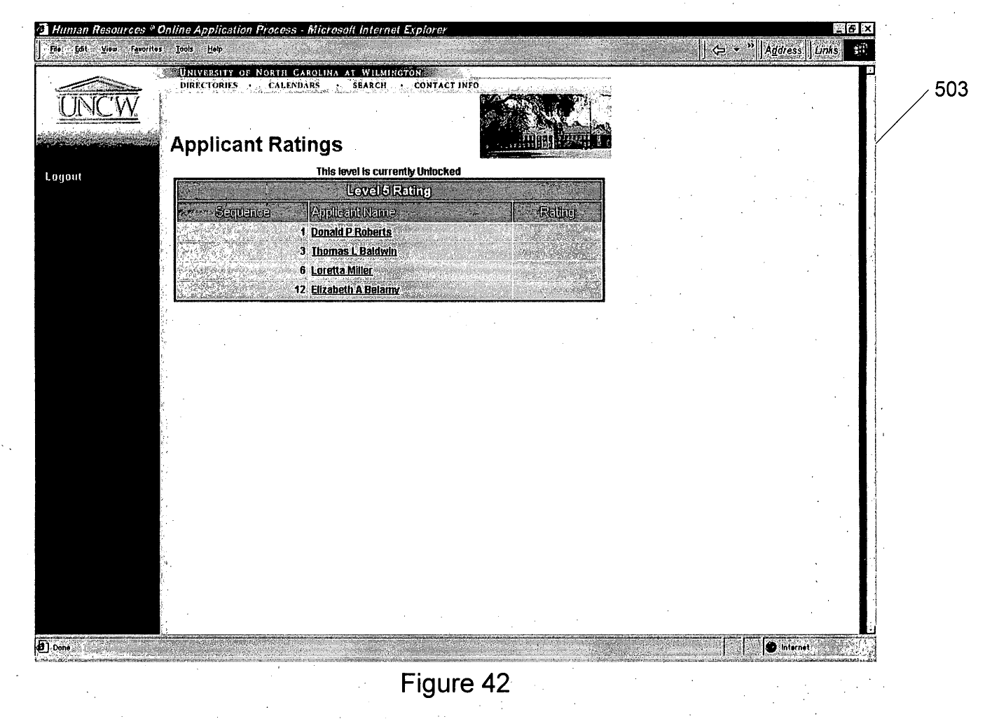

The Applicant Ratings at Level 5 for Interviews screen 503 is illustrated in FIG. 42 and is displayed to users who are a Search Committee Interviewer for the selected vacancy. The screen displays only the names of applicants who are at level 5, in the order in which their electronic applications were received.

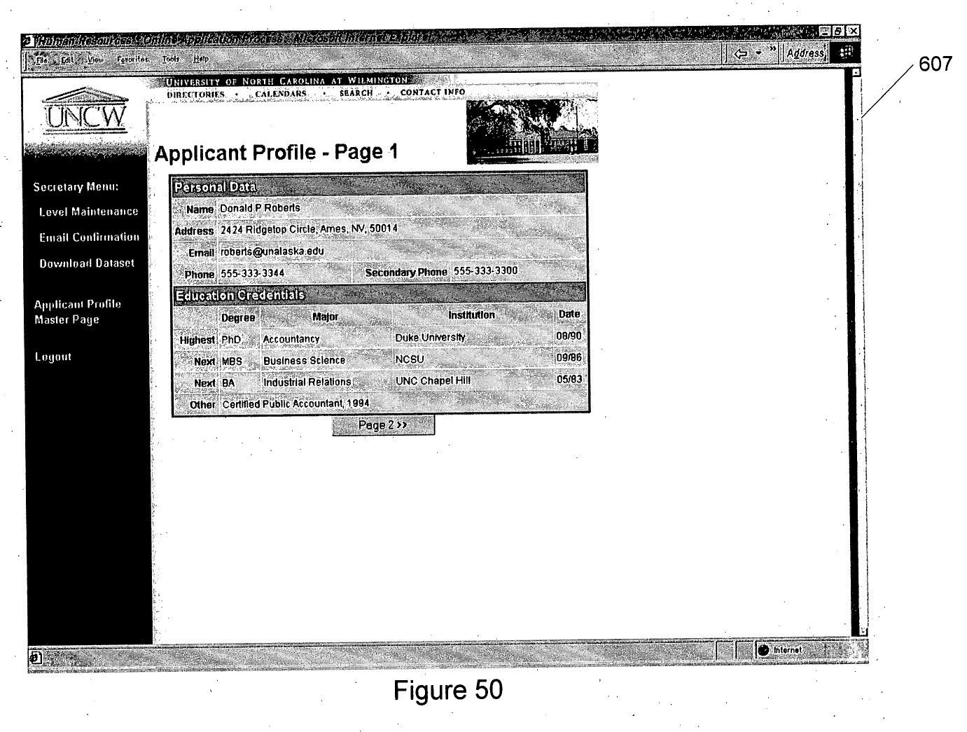

The Search Committee Interviewer clicks on the applicant's name to display Page 1 of the online application (607) (FIG. 50).

The Search Committee Interviewer can click on “Logout” in the left sidebar and return to the Committee Member Login screen (401) (FIG. 27).

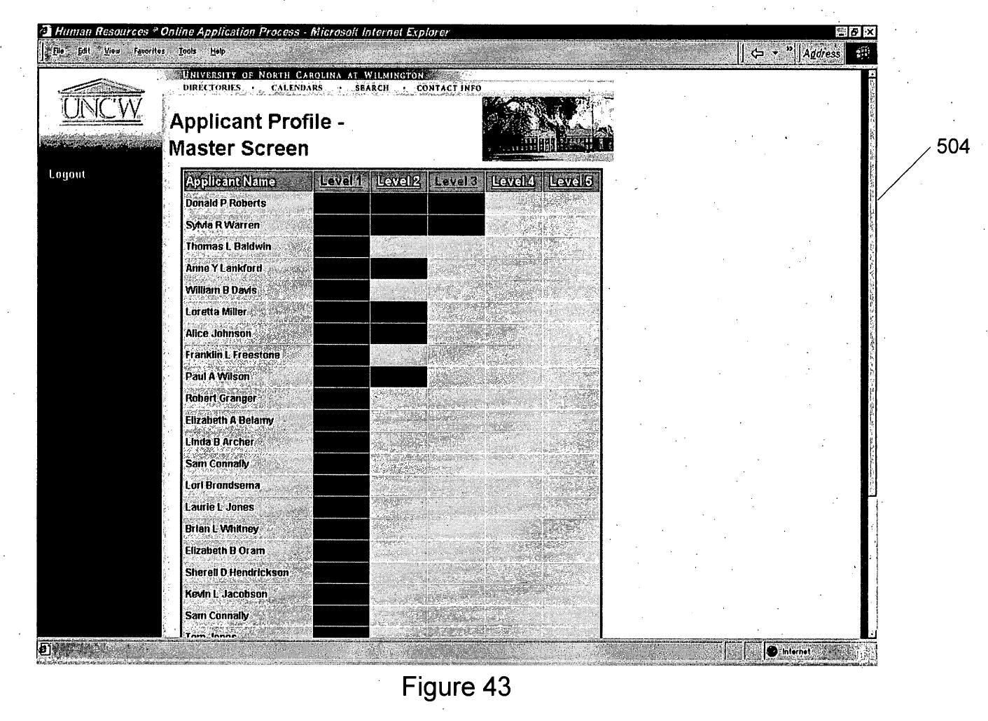

The Applicant Profile-Master Screen for Committee Member screen 504 is illustrated in FIG. 43 and is displayed to users who are a Search Committee Member for the selected vacancy. The screen displays the names of all applicants in the order in which their electronic applications were received. The five columns to the right of the names display the level to which each applicant has attained in the selection process by showing a bar moving through the columns.

On this screen, the Search Committee Member selects the level for which he/she desires to review the applications, and clicks on the column header.

The Search Committee Member can click on “Logout” in the left sidebar and return to the Committee Member Login screen (401) (FIG. 27).

Search Committee Chair can select “Download Dataset” from the Applicant Profile Master screen (502) (FIG. 41). The system launches MS Excel to display the Applicant Dataset (601) that is illustrated in FIG. 44. The data set contains the data entered by the applicants in their online applications. The Search Committee Chair can either save or delete the file.

The downloaded data fields are: Sequence number, the user ID entered by the applicant, the password entered by the applicant, system generated confirmation number, system assigned date of application, vacancy title, current level, applicant's last name, first name, middle initial, title, email address, phone number, alternate phone number, street address, city, state, zip code, Country, confirmation and filename of attached letter, confirmation and file name of Resume, confirmation and filename of references, title of current position, current employer, and dates of current position, title of former position, former employer, and dates of former employment, title of second former position, second former employer, and dates of second former employment, confirmation that information is complete, highest degree received and college or university awarding degree, next highest degree received and college or university awarding next highest degree, third highest degree received and college or university awarding third highest degree, other relevant credentials.

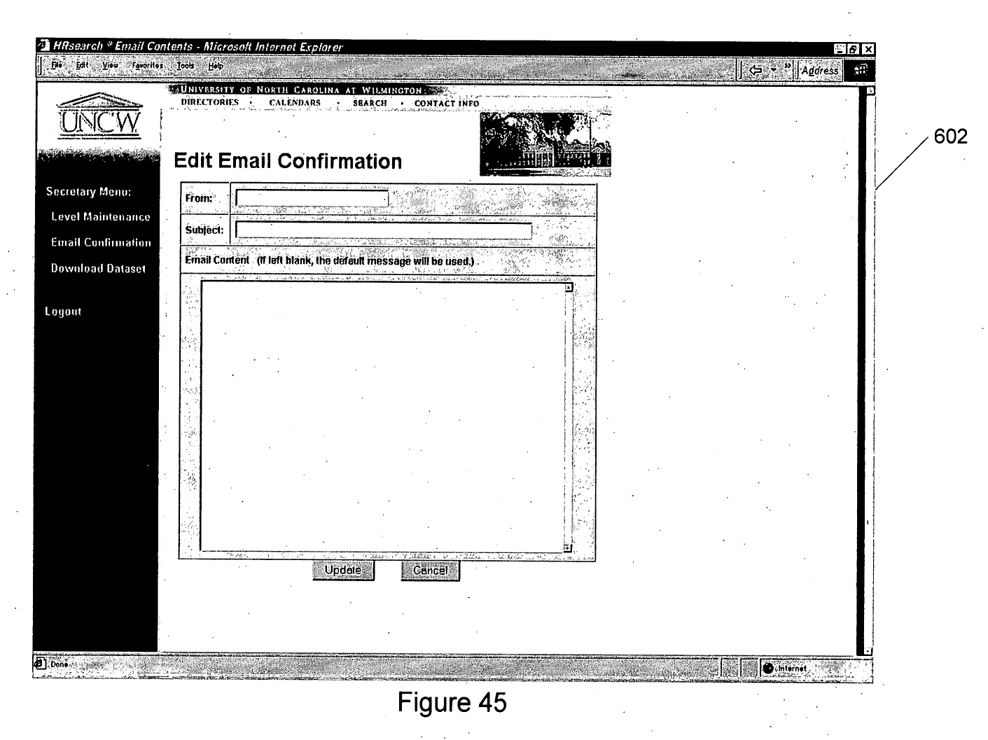

The Edit Email Confirmation screen 602 is illustrated in FIG. 45 and is used to enter and edit the email message (314) sent to applicants. It overrides the default email message (406) (FIG. 32) set up by the System Administrator. The Committee Chair can edit the “From” address, the “Subject” line, and the “Email Content”.

The Committee Chair can press the 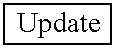
button to save changes. The system then displays the Applicant Profile Master screen (502) (FIG. 41).

The Committee Chair can press the 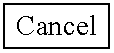
button to ignore any changes made on the screen. The system then displays the Applicant Profile Master screen (502) (FIG. 41).

The Committee Chair can click on “Level Maintenance” in the left sidebar to move applicants to different levels in the system (604) (FIG. 47).

The Committee Chair can click on “Email Confirmation” option in the left sidebar to edit the content of the automated email sent to applicants (314).

The Committee Chair can click on the “Download Dataset” option to download an excel file of applicant information (601) (FIG. 44).

The Committee Chair can click on the “Logout” option on the left sidebar and return to the Committee Member Login screen (401) (FIG. 27).

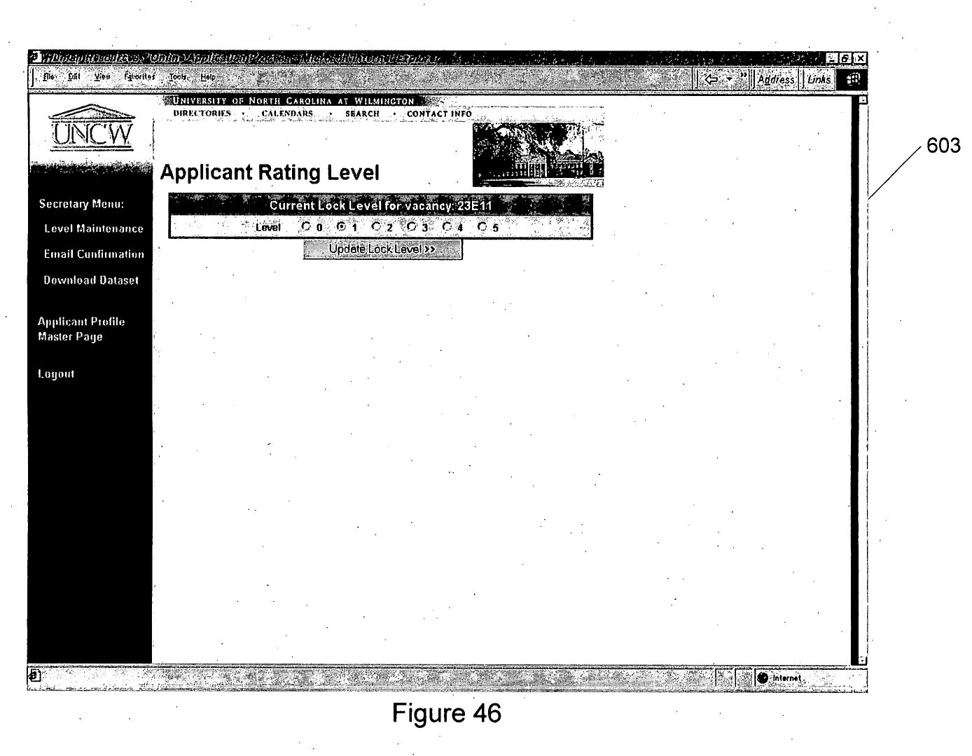

FIG. 46 illustrates the Applicant Rating Level screen 603. The Search Committee Chair uses this screen to lock in the rating scores at certain levels. For example, if the Search Committee is reviewing all applicants at level 3, then the Search Committee Chair will lock level 2. Locking level 2 locks the rating scores at that level and at all the levels below it. When a level is locked, a user cannot change his/her rating score of an applicant.

When the Search Committee Chair presses 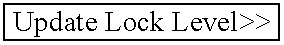
the system saves the information.

The Committee Chair can click on “Level Maintenance” in the left sidebar to move applicants to different levels in the system (604) (FIG. 47).

The Committee Chair can click on “Email Confirmation” option in the left sidebar to edit the content of the automated email sent to applicants (314).

The Committee Chair can click on the “Download Dataset” option to download an excel file of applicant information (601) (FIG. 44).

The Committee Chair can click on “Applicant Profile Master Page” on the left sidebar and return to the Applicant Profile Master screen (502) (FIG. 41).

The Committee Chair can click on the “Logout” option on the left sidebar and return to the Committee Member Login screen (401) (FIG. 27).

FIG. 47 illustrates the Applicant Level screen 604. This screen displays all applicants for a vacancy and their current level.

To move an applicant to another level, the Committee Chair can first click on an applicant's name to display the Applicant Rating Level screen (610) (FIG. 53).

The Committee Chair can click on “Lock Level” option on the left sidebar to lock and unlock ratings at each level (603) (FIG. 46).

The Committee Chair can click on “Email Confirmation” option in the left sidebar to edit the content of the automated email sent to applicants (314).

The Committee Chair can click on the “Download Dataset” option to download an excel file of applicant information (601) (FIG. 44).

The Committee Chair can click on the “Applicant Profile Master Page” on the left sidebar and return to the Applicant Profile—Master screen (502) (FIG. 41).

The Committee Chair can click on the “Logout” option on the left sidebar and return to the Committee Member Login screen (401) (FIG. 27).

FIG. 48 illustrates the Consolidated Ratings screen 605. For a specific level, the Search Committee Chair can view the ratings entered by all Committee Chairs, Committee Members, and Interviewers for applicants on that level. To display the ratings entered by all committee participants, the system builds a screen (605) called “Consolidated Ratings”, which displays a matrix for applicants at that level in which the applicants' sequence number and name are displayed in a left hand column (sorted by sequence number) and all Committee Chairs', Committee Members', and Interviewers' initials are in the uppermost row. The consolidated rating screen displays the rating (using X, /, O symbols) entered by any and all Committee Chairs, Committee Members, and Interviewers for any and all applicants. Furthermore, the consolidated ratings screen displays the total number of X ratings, the total number of / ratings, and the total number of O ratings for each applicant in the rightmost columns.

The Search Committee Chair, when viewing the “consolidated ratings” screen, can print the page and download the matrix into an Excel spreadsheet (610) (FIG. 53). These options occur at the bottom edge of the Consolidated Ratings screen (605) (FIG. 48).

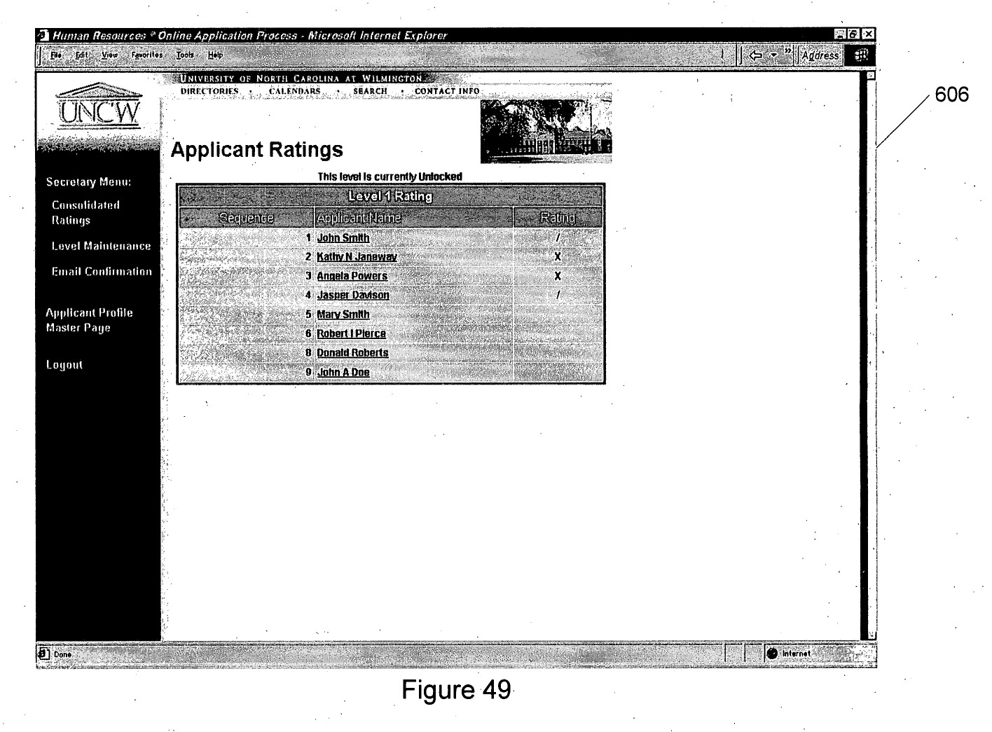

FIG. 49 illustrates an Applicant Ratings screen 606. This screen displays all applicants and their sequence number at the level previously selected by the user. The page also indicates if the level is either “locked” which means that the user cannot enter or change an applicant's rating, or “unlocked”, which means that the user can enter or change an applicant's rating.

The Committee Member and Committee Chair can click on the applicant's name to view the first page of the applicant's application materials (607) (FIG. 50).

The Committee Chair can click on “Consolidated Ratings” in the left sidebar to see the ratings of the Committee Members (605) (FIG. 48).

The Committee Chair can click on “Level Maintenance” in the left sidebar to move applicants to different levels in the system (604) (FIG. 47).

The Committee Chair can click on “Email Confirmation” in the left sidebar to edit the content of the automated email sent to applicants (314).

The Committee Member and Committee Chair can click on “Applicant Profile Master Page” in the left sidebar and return to the Applicant Profile—Master screen (502) (FIG. 41).

The Committee Member and Committee Chair can click on the “Logout” option in the left sidebar and return to the Committee Member Login screen (401) (FIG. 27).

FIG. 50 illustrates Page 1 of the Applicant Profile screen 607. This screen displays the information entered by the applicant: Name, Address, email address, phone number, and education credentials.

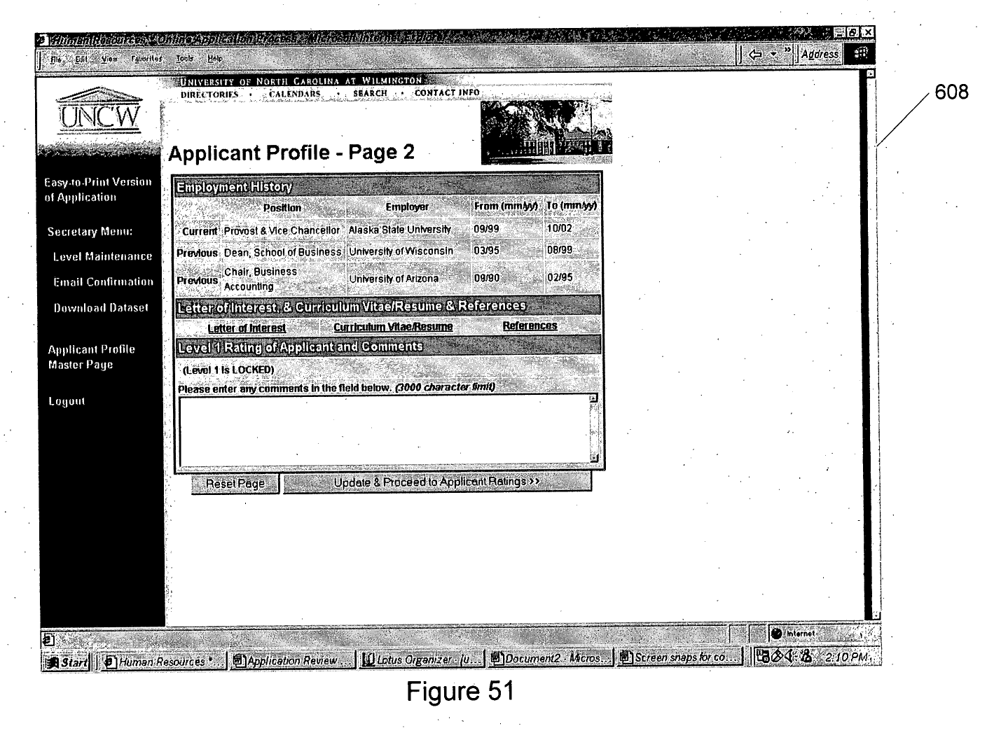

The Committee Chair, Interviewer, and Committee Member can press 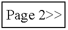
to display Page 2 of the applicant's application (FIG. 51).

The Committee Chair can click on “Level Maintenance” in the left sidebar to move applicants to different levels in the system (604) (FIG. 47).

The Committee Chair can click on “Email Confirmation” in the left sidebar to edit the content of the automated email sent to applicants (314).

The Committee Chair can click on the “Download Dataset” option to download an excel file of applicant information (601) (FIG. 44).

The Committee Member and Committee Chair can click on the Applicant Profile Master Page on the left sidebar and return to the Applicant Profile—Master screen (502) (FIG. 41).

The Committee Member and Committee Chair can click on “Logout” in the left sidebar and return to the Committee Member login screen (401) (FIG. 27).

FIG. 51 illustrates Page 2 of the Applicant Profile screen 608. This page displays the information entered by the applicant: Current and two previous positions, and links to three documents (307, 308, 309) submitted by the applicant (Letter of Interest, Resume, and References).

The user can click on Letter of Interest, Curriculum Vitae\Resume, and References. This will launch MS Word, Adobe Acrobat and/or another application to display the documents (307, 308, 309) that the applicant attached to his/her online application.

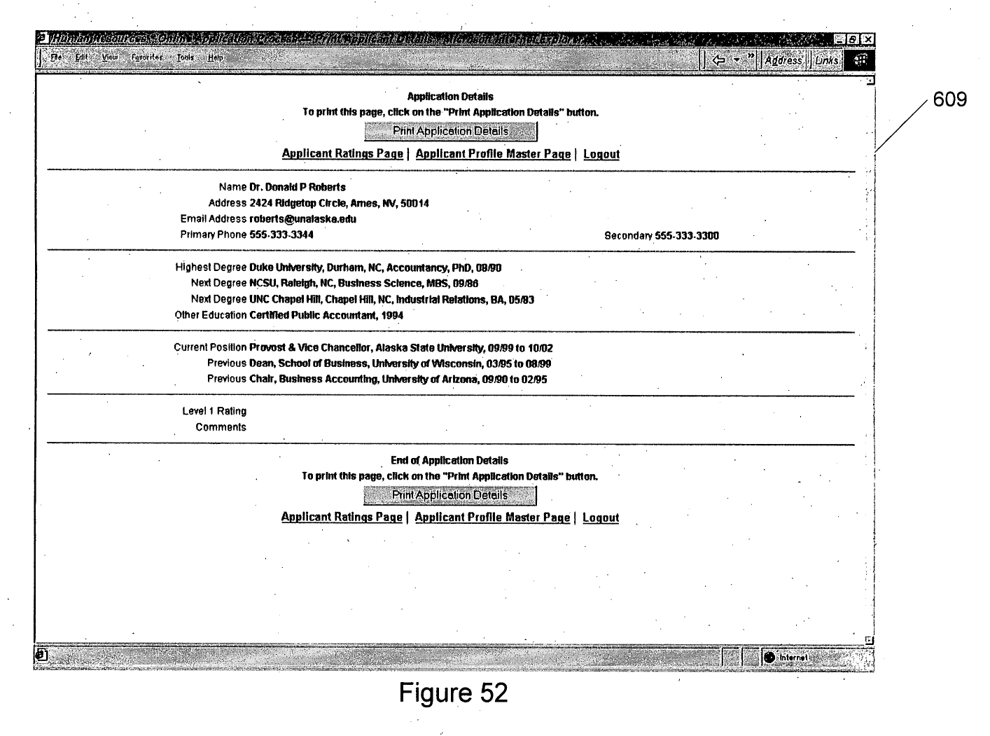

The user can click on “Easy-to-Print Version of Application” to display a one-page summary (609) (FIG. 52) of the applicant's information and the rating and comments entered by the Committee Chair, Committee Member, or Interviewer.

The Committee Chair can click on “Level Maintenance” in the left sidebar to move applicants to different levels in the system (604) (FIG. 47).

The Committee Chair can click on “Email Confirmation” in the left sidebar to edit the content of the automated email sent to applicants (314).

The Committee Chair, Committee Member, and Interviewer can press the 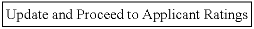
button to return to the Applicant Ratings screen (606) (FIG. 49).

The Committee Member and Committee Chair can click on “Applicant Profile Master Page” on the left sidebar and return to the Applicant Profile—Master screen (502) (FIG. 41).

The user can click on “Logout” on the left sidebar and return to the Committee Member Login screen (401) (FIG. 27).

FIG. 52 illustrates the Application Summary screen 609. The user can open and print a screen of a summary of the applicant's information (609), and the evaluation and comments entered by the user. The evaluation of Highly Recommended, Moderately Recommended, and Not Recommended are represented by the following symbols: Highly Recommended (X), Moderately Recommended (/) and Not Recommended (O).

FIG. 53 illustrates a Consolidated Ratings-Excel Spreadsheet 610. For a specific level, the Search Committee Chair can view the ratings entered by all committee chairs, members, and interviewers for applicants on that level. To display the ratings entered by all committee participants, the system builds a screen 605 (FIG. 48) called “Consolidated Ratings”, which displays a matrix for applicants at that level in which the applicants' sequence number and name are displayed in a left hand column (sorted by sequence number) and all committee members' initials are in the uppermost row. The consolidated rating screen displays the rating (using X, /, O symbols) entered by any and all committee Chairs, members and interviewers for any and all applicants. Furthermore, the consolidated ratings screen displays the total number of X scores, the total number of / ratings, and the total number of O ratings for each applicant in the rightmost columns.

The Search Committee Chair, when viewing the “Consolidated Ratings” screen, can print the page and download the matrix into an excel spreadsheet (610) (FIG. 53). These options occur at the bottom edge of the Consolidated Ratings screen (605) (FIG. 48). The excel spreadsheet allows the Search Committee Chair the option of sorting and manipulating the data.

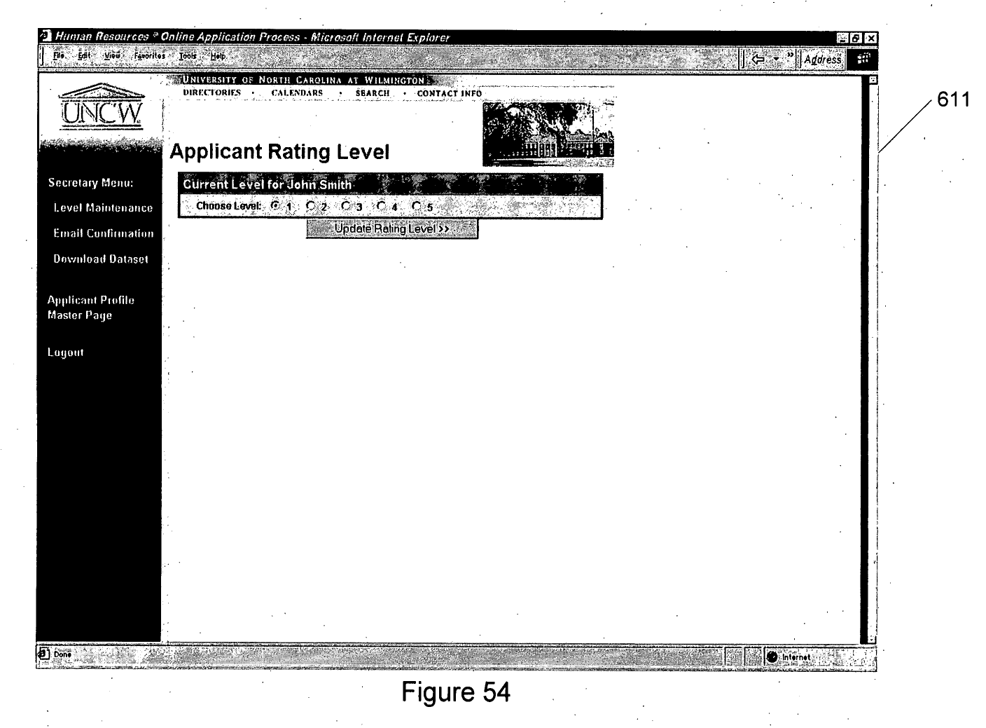

FIG. 54 illustrates an Applicant Rating Level screen 611. To move an applicant to another level, the Committee Chair can select the level (1-5) and then press the 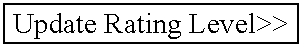
button. This will return the Committee Chair to the Applicant Level screen (604) (FIG. 47).

The Committee Chair can click on “Level Maintenance” in the left sidebar to move applicants to different levels in the system (604) (FIG. 47).

The Committee Chair can click on “Email Confirmation” option in the left sidebar to edit the content of the automated email sent to applicants (314).

The Committee Chair can click on the “Download Dataset” option to download an excel file of applicant information (601) (FIG. 44).

The Committee Chair can click on the “Applicant Profile Master Page” on the left sidebar and return to the Applicant Profile—Master screen (502) (FIG. 41).

The Committee Chair can click on the “Logout” option on the left sidebar and return to the Committee Member login screen (401) (FIG. 27).

It will be understood by those having skill in the art that embodiments of the present invention have been described in connection with academic Search Committees. However, other embodiments of the present invention may be used in other job application processes in industrial or other non-academic environments, wherein an applicant pool is narrowed to successive levels and broadened at an interview stage under the auspices of an in-house hiring committee.

In the drawings and specification, there have been disclosed embodiments of the invention and, although specific terms are employed, they are used in a generic and descriptive sense only and not for purposes of limitation, the scope of the invention being set forth in the following claims.

1. A method for facilitating evaluation of a plurality of job applicants by a search committee comprising:
tracking online, successive online evaluations of the plurality of job applicants at successive stages of a search process by members of the search committee in order to narrow a list of candidates for a job from an initial set of job applicants to a final set of job applicants that is smaller than the initial set.

2. A method according to claim 1 wherein tracking online comprises displaying a matrix that includes search committee member ratings for at least some of the job applicants at the successive stages of the search process.

3. A method according to claim 2 wherein the search committee ratings are not displayed as number grade rankings or letter grade rankings.

4. A method according to claim 3 wherein the matrix also includes a total number of a given search committee member rating for at least some of the job applicants at the successive stages of the search process.

5. A method according to claim 1 wherein tracking online comprises displaying a matrix that indicates which search committee member reviews have been completed for at least some of the job applicants at the successive stages of the search process.

6. A method according to claim 1 wherein tracking online is followed by:
tracking online, results of interviews with the final set of job applicants by the members of the search committee and other interviewers.

7. A method according to claim 1 wherein the plurality of job applicants are a plurality of academic job applicants and wherein the search committee is an academic search committee.

8. A method according to claim 1 wherein tracking online is preceded by accepting online applications from the plurality of job applicants and wherein tracking online comprises electronically distributing the online applications to the members of the search committee.

9. A method according to claim 1 wherein tracking online comprises accepting online, a search committee member rating for a given applicant at a given stage of the search process without allowing the search committee member to view online ratings of other search committee members for the given applicant at the given stage of the search process.

10. A method according to claim 1 wherein tracking online comprises accepting online input from a chair of the search committee to advance selected job applicants from a preceding stage of the search process to a succeeding stage of the search process.

11. A computer program product that is configured to facilitate evaluation of a plurality of job applicants by a search committee, the computer program product comprising a computer usable storage medium having computer-readable program code embodied in the medium, the computer-readable program code comprising:
computer-readable program code that is configured to track successive online evaluations of the plurality of job applicants at successive stages of a search process by members of the search committee in order to narrow a list of candidates for a job from an initial set of job applicants to a final set of job applicants that is smaller than the initial set.

12. A computer program product according to claim 11 wherein the computer-readable program code that is configured to track comprises computer-readable program code that is configured to display a matrix that includes search committee member ratings for at least some of the job applicants at the successive stages of the search process.

13. A computer program product according to claim 12 wherein the search committee ratings are not displayed as number grade rankings or letter grade rankings.

14. A computer program product according to claim 13 wherein the matrix also includes a total number of a given search committee member rating for at least some of the job applicants at the successive stages of the search process.

15. A computer program product according to claim 11 wherein the computer-readable program code that is configured to track comprises computer-readable program code that is configured to display a matrix that indicates which search committee member reviews have been completed for at least some of the job applicants at the successive stages of the search process.

16. A computer program product according to claim 11 further comprising:
computer-readable program code that is configured to track results of interviews with the final set of job applicants by the members of the search committee and other interviewers.

17. A computer program product according to claim 11 wherein the plurality of job applicants are a plurality of academic job applicants and wherein the search committee is an academic search committee.

18. A computer program product according to claim 11 further comprising:
computer-readable program code that is configured to accept online applications from the plurality of job applicants; and
wherein the computer-readable program code that is configured to track comprises computer-readable program code that is configured to distribute the online applications to the members of the search committee.

19. A computer program product according to claim 11 wherein the computer-readable program code that is configured to track comprises computer-readable program code that is configured to accept a search committee member rating for a given applicant at a given stage of the search process without allowing the search committee member to view ratings of other search committee members for the given applicant at the given stage of the search process.

20. A computer program product according to claim 11 wherein the computer-readable program code that is configured to track comprises computer-readable program code that is configured to accept input from a chair of the search committee to advance selected job applicants from a preceding stage of the search process to a succeeding stage of the search process.

21. A system for facilitating evaluation of a plurality of job applicants by a search committee comprising:
a server that is configured to track successive online evaluations of the plurality of job applicants at successive stages of a search process by members of the search committee in order to narrow a list of candidates for a job from an initial set of job applicants to a final set of job applicants that is smaller than the initial set.

22. A system according to claim 21 wherein the server is further configured to generate a matrix that includes search committee member ratings for at least some of the job applicants at the successive stages of the search process.

23. A system according to claim 22 wherein the search committee ratings are not displayed as number grade rankings or letter grade rankings.

24. A system according to claim 23 wherein the matrix also includes a total number of a given search committee member rating for at least some of the job applicants at the successive stages of the search process.

25. A system according to claim 21 wherein the server is further configured to generate a matrix that indicates which search committee member reviews have been completed for at least some of the job applicants at the successive stages of the search process.

26. A system according to claim 21 wherein the server is further configured to track results of interviews with the final set of job applicants by the members of the search committee and other interviewers.

27. A system according to claim 21 wherein the plurality of job applicants are a plurality of academic job applicants and wherein the search committee is an academic search committee.

28. A system according to claim 21 wherein the server is further configured to accept online applications from the plurality of job applicants and to distribute the online applications to the members of the search committee.

29. A system according to claim 21 wherein the server is further configured to accept a search committee member rating for a given applicant at a given stage of the search process without allowing the search committee member to view ratings of other search committee members for the given applicant at the given stage of the search process.

30. A system according to claim 21 wherein the server is further configured to accept input from a chair of the search committee to advance selected job applicants from a preceding stage of the search process to a succeeding stage of the search process.

31. A system for facilitating evaluation of a plurality of job applicants by a search committee comprising:
a search committee chair terminal that is configured to display a matrix that includes search committee member ratings for a plurality of job applicants at successive stages of a search process.

32. A system according to claim 31 wherein the search committee ratings are not displayed as number grade rankings or letter grade rankings.

33. A system according to claim 32 wherein the matrix also includes a total number of a given search committee member rating for at least some of the job applicants at the successive stages of the search process.

34. A system according to claim 31 wherein the matrix also includes results of interviews with the final set of job applicants by the members of the search committee and other interviewers.

35. A system according to claim 31 wherein the plurality of job applicants are a plurality of academic job applicants and wherein the search committee is an academic search committee.

36. A system according to claim 31 wherein the search committee chair terminal is further configured to accept input from a chair of the search committee to advance selected job applicants from a preceding stage of the search process to a succeeding stage of the search process.
